(19) United States
(12) Patent Application Publication
(10) Pub. No.: US 2021/0008559 A1
(43) Pub. Date: Jan. 14, 2021

(54) CAPSULE CONTAINMENT OF DRIED REAGENTS

(71) Applicant: TALIS BIOMEDICAL CORPORATION, Menlo Park, CA (US)

(72) Inventors: Thomas H. CAULEY, III, Redwood City, CA (US); Melvin YAMAMOTO, Fremont, CA (US)

(21) Appl. No.: 16/468,588

(22) PCT Filed: Dec. 8, 2017
(86) PCT No.: PCT/US2017/065444

§ 371 Date: Jun. 11, 2019

Related U.S. Application Data
(60) Provisional application No. 62/433,134, filed on Dec. 12, 2016.
(60) Provisional application No. 62/539,998, filed on Aug. 1, 2017.

(51) Int. Cl. B01L 3/00

(52) U.S. Cl. CPC B01L 3/523; B01L 3/527; B01L 2300/048; B01L 2300/044; B01L 2300/042; B01L 3/502715

(57) ABSTRACT

Disclosed herein are methods and devices for preparing a dried reagent for long term storage and rehydrating and mixing the dried reagent.

### CROSS-REFERENCE TO RELATED APPLICATIONS

This application claims the benefit of U.S. Provisional Patent Application No. 62/433,134, filed Dec. 12, 2016, and U.S. Provisional Patent Application No. 62/539,998, filed Aug. 1, 2017, the disclosures of which are incorporated herein by reference.

### FIELD OF THE INVENTION

The invention relates to methods and devices for preparing a dried reagent for long term storage and providing the dried reagent to a microfluidic system for rehydration.

### BACKGROUND OF THE INVENTION

Lab-on-a-chip or other diagnostic systems that use microfluidic components to carry out real-time analysis of biological samples have great potential for applications in the broad field of scientific research and diagnostic applications. For such devices, various reagents are required for sample preparation and analysis.

For an integrated solution to be realized, automated reagent delivery systems and reagent containment with the capability for long term storage are needed. Reagent storage and integration, including automated processing, ease of use, contamination avoidance and transportation risk, represents a significant challenge to developing diagnostic systems, such as a lab-on-a-chip. To meet this challenge, two key goals are envisioned, the long-term storage of reagents without significant loss or interaction with the surroundings, and the on-demand release of liquids containing a uniform distribution of the stored reagent or biomolecules.

Long-term stability of the prestored reagents enables full functionality of the assay up to its expiration date. To preserve reagents for long term storage, state-of-the-art techniques, such as freeze-drying (i.e., lyophilization) can be used. Lyophilization facilitates both long term storage and rapid dissolution of the reagent into a solvent when ready to use. However, lyophilized products can be extremely hydroscopic and must be sealed in air tight containers (e.g., capsules) following freeze drying to prevent rehydration from atmospheric exposure.

Where dried reagents (e.g., lyophilized or freeze-dried reagents) are used, unwanted exposure to contaminants, including moisture or moisture vapor during storage and prior to reconstitution, may contaminate or compromise the stability of the reagent. This can lead to a decrease in the reagent's ability to rapidly rehydrate, interfering with the concentration and homogeneity of a rehydrated reagent in an assay device. Additionally, contamination may interfere with biological and chemical activities of the reagent, may prematurely activate the reagent, or can allow it to prematurely break down thereby decreasing the effectiveness of the reagent. Even small errors, such as failure to fully reconstitute the reagent into a homogenous solution, may have undesirable consequences, including the generation of false positives or false negatives.

Most microfluidic devices are not set up to allow in situ lyophilization or vacuum drying directly onto the device. Additional assembly is required after the reagents are place within wells or channels of the partially assembled device, and this assembly is not compatible with freeze-drying technology on a commercial scale. Such assembly of microfluidic cartridges can expose a lyophilized reagent to moist or hot environments that can inactivate dried reagents.

Current lyophilization services predominantly use commercially available vials, bottles, tubes, microtiter well plates, syringes and cartridges. The cylindrical or tubular configuration of these containers conforms to automated filling and capping systems, but is not designed to provide reagent containment to microfluidic cartridges. Specifically, these commercially available components are not designed to provide a sealed transfer of the lyophilized reagent from a lyophilization tube to another location, such as on an assay chip, where contamination of the lyophilized reagent can lead to the undesirable results.

As a result, custom applications requiring reagent containment have typically used fluidic dispense and in-situ dry down for storage. While simple, this process has stability and rehydration or activation issues which limit the assay performance. In contrast, lyophilized reagents readily rehydrate and are shown to have long shelf life stability.

What is needed, therefore, are custom designed components that facilitate preparation and containment for long term storage of a dried reagent, while also providing an interface with a lab-on-a-chip or other diagnostic system to enable rapid and homogenous dissolution and automated delivery of the reagent to the diagnostic chip or other microfluidic system or integrated miniature device.

### SUMMARY OF THE INVENTION

In some embodiments, provided herein is a reagent storage component comprising a capsule capable of holding a liquid or solid sample, the capsule comprising an opening, a closed end and a wall extending from the closed end to the opening, wherein the capsule is oval-shaped and the wall is rounded, and wherein the closed end and wall define an interior volume having a substantially smooth surface.

In some embodiments, the capsule comprises a baffle attached to the capsule wall, wherein sad baffle splits the capsule into two or more flow-through ports, wherein the baffle comprises an interconnecting channel such that the flow-through ports are in fluidic communication via the interconnecting channel, and wherein the interior volume of the capsule comprises the flow-through ports and the interconnecting channel.

In some embodiments, the closed end is part of a continuous component with the wall. In some embodiments, the closed end comprises a concave shape extending from the bottom of the capsule. In some embodiments, the closed end is formed by a material attached to the bottom of the capsule. In some embodiments, the material is a film layer. In some embodiments, the material is an impermeable membrane. In some embodiments, the material is a hydrophobic porous membrane.

In some embodiments, provided herein is a reagent storage component comprising a main body comprising a first surface, a second surface, and a capsule comprising first and second flow-through ports and an interconnecting channel, wherein each of the flow-through ports extend from the first surface to the second surface and the interconnecting channel connects the first and second flow-through ports, and wherein the first and second flow-through ports and the interconnecting channel together define an interior volume of the capsule; and an impermeable membrane affixed to the second surface. In some embodiments, the reagent storage component further comprises a dissolved reagent in the interior volume and a vapor permeable membrane affixed to the first surface. In some embodiments, the reagent storage component further comprises a dried reagent in the interior volume and a vapor permeable membrane affixed to the first surface. In some embodiments, the reagent storage component further comprises a capping film covering the vapor permeable membrane at the first surface such that the interior volume of the capsule is sealed.

Also provided herein is a reagent storage component comprising: a main body comprising a first surface, a second surface, and a capsule comprising first and second flow-through ports and an interconnecting channel, wherein each of the flow-through ports extend from the first surface to the second surface and the interconnecting channel connects the first and second flow-through ports, and wherein the first and second flow-through ports and the interconnecting channel together define an interior volume of the capsule; and a vapor permeable membrane affixed to the first surface. In some embodiments, the reagent storage component further comprises a dissolved reagent in the interior volume and an impermeable membrane affixed to the second surface. In some embodiments, the reagent storage component further comprises a dried reagent in the interior volume and an impermeable membrane affixed to the second surface. In some embodiments, the reagent storage component further comprises a capping film covering the vapor permeable membrane at the first surface such that the interior volume of the capsule is sealed.

In some embodiments, the vapor permeable membrane is a porous membrane. In some embodiments, the vapor permeable membrane is hydrophobic. In some embodiments, the vapor permeable membrane comprises a cap comprising an adjustable vent.

In some embodiments, the impermeable membrane comprises a sealing film. In some embodiments, the impermeable membrane is frangible. In some embodiments, the capping film or the impermeable membrane is frangible.

In some embodiments, the interconnecting channel is adjacent to the first surface. In some embodiments, the interconnecting channel is adjacent to the second surface. In some embodiments, the interconnecting channel is not adjacent to the first surface or the second surface.

Also provided herein is a reagent storage component comprising a capsule capable of holding a liquid or a solid sample, the capsule comprising an inner surface extending from the bottom of the capsule to an oval-shaped opening at the top of the capsule, wherein the inner surface is substantially smooth and comprise a concave shape extending from the bottom of the capsule; and a planar layer affixed around the oval-shaped opening of the capsule and oriented in the same plane as the oval-shaped opening of the capsule, wherein the planar layer comprises a top surface and a bottom surface, the top surface aligned with the inner surface of the capsule at the oval-shaped opening to provide a continuous surface.

In some embodiments, the oval-shaped opening narrows from the top of the capsule. In some embodiments, the narrowing occurs at an angle of 5 to 15 degrees. In some embodiments, the opening is elliptical. In some embodiments, the inner surface of the capsule comprises an ovoidal shape. In some embodiments, the inner surface of the capsule comprises an ellipsoidal shape.

In some embodiments, the ratio of the longest diameter and the shortest diameter of a cross-section of the capsule parallel to the plane of the oval-shaped opening is greater than 1.05, 1.10, 1.2, 1.3, 1.4, 1.5, 1.6, 1.7, 1.8, 1.9 or 2.0. In some embodiments, the height of the capsule is about 8 mm. In some embodiments, the capsule is capable of holding a volume of about 30 μL, 40 μL, 50 μL, 60 μL, 70 μL, 80 μL, 90 μL, 100 μL, 110 μL, 120 μL, 130 μL, 140 μL, 150 μL, 160 μL, 170 μL, 180 μL, 190 μL, or 200 μL. In some embodiments, the capsule is capable of holding a volume from approximately 50 μL to approximately 200 μL.

In some embodiments, the capsule is capable of holding a volume from approximately 170 μL to approximately 190 μL. In some embodiments, the oval-shaped opening is contained within an area of 9 mm×9 mm. In some embodiments, the planar layer is no more than 9 mm×9 mm. In some embodiments, the planar layer is square shaped.

In some embodiments, the reagent storage component further comprises a seal enclosing the capsule to form a fluid tight environment for reagent storage, wherein the capsule comprises a dried reagent. In some embodiments, the reagent storage component further comprises a permeable membrane affixed to the top surface. In some embodiments, the reagent storage component further comprises an impermeable membrane affixed to the permeable membrane such that the interior volume of the capsule is enclosed to form a fluid tight environment for reagent storage. In some embodiments, the capsule comprises a dried reagent.

In some embodiments, the reagent storage component further comprises an impermeable membrane affixed to the top surface such that the interior volume of the capsule is enclosed to form a fluid tight environment for reagent storage, wherein the capsule comprises a dried reagent.

Also provided herein is a module comprising a reagent storage component comprising a capsule, and a cap directly or indirectly mounted to the opening of the capsule to form a fluid tight engagement with the capsule.

In some embodiments, the cap comprises an adjustable venting channel capable of being moved from an open position, wherein the venting channel is open to allow air to pass through the cap, to a closed position, wherein the venting channel is closed to prevent air from passing through the cap.

In some embodiments, the module further comprises an interface unit mounted between the capsule opening and the cap, the interface unit comprising a through hole, the through hole aligning the capsule with the cap such that the cap is indirectly mounted to the opening of the capsule to form the fluid tight engagement.

In some embodiments, the interface unit comprises a lower engaging member at the bottom of the through hole, wherein the lower engaging member comprises a first raised surface comprising a first edge, the first raised surface mounted into the oval-shaped opening of the capsule to form a fluid tight engagement between the capsule and the through hole of the interface unit. In some embodiments, the first raised surface is oval shaped. In some embodiments, the first edge is angled such that the lower engaging member is tapered to form a fluid tight engagement with the capsule.

In some embodiments, the interface unit comprises an upper engaging member at the top of the through hole, wherein the upper engaging member comprises a second raised surface comprising a second edge, the second raised surface mounted to the cap to form a fluid tight engagement between the cap and the through hole of the interface unit.

In some embodiments, the second raised surface is circular. In some embodiments, the second edge is angled such that the upper engaging member is tapered to form a fluid tight engagement with the cap. In some embodiments, the cap is inserted into the interior of the top of the through hole of the interface unit to form a fluid tight engagement between the cap and the interface unit.

Also provided herein is an array comprising a plurality of reagent storage components each comprising a capsule. In some embodiments, the array comprises a plurality of the reagent storage components immobilized in a nesting layer, the nesting layer comprising a plurality of slots configured to hold the plurality of reagent storage components. In some embodiments, the array is an ordered array. In some embodiments, the ordered array comprises a spacing of 9 mm between the center of adjacent capsules along a horizontal axis or vertical axis or both. In some embodiments, the ordered array comprises 96 capsules.

In some embodiments, the reagent storage component comprises a planar layer and the planar layers of each of the plurality of reagent storage components are attached to each other to form a continuous plane, thereby forming the array. In some embodiments, the array comprises a plurality of reagent storage components immobilized in a nesting layer, the nesting layer comprising a plurality of slots configured to hold the plurality of reagent storage components. In some embodiments, the plurality of slots in the nesting layer engage an outer surface of the capsule and the bottom surface of the planar layer to immobilize each reagent storage component.

In some embodiments, the array comprises a seal enclosing each of the capsules in the plurality of reaction storage components to form a fluid tight environment for reagent storage. In some embodiments, the array comprises a vapor permeable seal affixed to the top surface of each of the capsules of the plurality of reaction storage components.

Also provided herein is a module comprising an array of reagent storage components each comprising a capsule, a plurality of caps directly or indirectly mounted to the opening of each of the plurality of capsules of the reagent storage components to form a fluid tight engagement with each capsule, wherein the plurality of caps each comprise an adjustable venting channel capable of being moved from an open position, wherein the venting channel is open to allow air to pass through the cap, to a closed position, wherein the venting channel is closed to prevent air from passing through the cap.

In some embodiments, the module comprising an array of storage components further comprises an interface layer comprising a plurality of through holes, each through hole mounted to and aligning one of the plurality of capsules with one of the plurality of caps to indirectly mount the plurality of caps to the plurality of capsules to form the fluid tight engagement. In some embodiments, the interface layer comprises plurality of lower engaging members at the bottom of each through hole, wherein the lower engaging members each comprise a first raised surface comprising a first edge, each of the first raised surfaces mounted into the oval-shaped opening of one of the plurality of capsules to form a fluid tight engagement between the capsule and the through hole of the interface layer. In some embodiments, the first raised surface is oval shaped. In some embodiments, the first edge is angled such that the lower engaging member is tapered to form a fluid tight engagement with the capsule. In some embodiments, the interface layer comprises a plurality of upper engaging members at the top of each through hole, wherein the upper engaging members each comprise a second raised surface comprising a second edge, each of the second raised surfaces mounted to one of the plurality of caps to form a fluid tight engagement between the cap and the through hole of the interface layer. In some embodiments, the second raised surface is circular. In some embodiments, the second edge is angled such that the upper engaging member is tapered to form a fluid tight engagement with the cap. In some embodiments, the plurality of caps are inserted into the interior of the top of the plurality of through holes of the interface layer such that a fluid tight engagement is formed between each of the plurality of caps and the plurality of through holes of the interface layer.

Also provided herein is a microfluidic device comprising an oval-shaped raised surface on the microfluidic device, wherein the oval-shaped raised surface comprises an inlet and an outlet, the raised surface comprising edges that form a fluid tight engagement with the inner surface of the capsule of the reagent storage component; and a reagent storage component comprising a capsule comprising an oval-shaped opening, wherein the oval-shaped opening is engaged with the raised surface to form a fluid tight seal to compartmentalize the capsule. In some embodiments, the capsule comprises a mixing element. In some embodiments, the mixing element comprises a magnetic bead. In some embodiments, the capsule comprises a dried reagent.

Also provided herein is a method of preparing a dried reagent, the method comprising the steps of: providing a reagent storage component comprising a main body comprising a first surface, a second surface, a capsule comprising first and second flow-through ports and an interconnecting channel, and an impermeable membrane affixed to the second surface; dispensing a dissolved reagent into the interior volume of the capsule; applying a porous membrane to the first surface of the main body to enclose the dissolved reagent within the interior volume, thereby forming a capsule competent for reagent drying; drying the dissolved reagent in the capsule to remove solvent from the reagent, thereby filling the interior volume with a dried reagent; and applying a capping film to the porous membrane to isolate the dried reagent from an outside environment.

Also provided herein is a method of preparing a dried reagent, the method comprising the steps of providing a reagent storage component comprising a main body comprising a first surface, a second surface, a capsule comprising first and second flow-through ports and an interconnecting channel, and a vapor permeable membrane affixed to the first surface; dispensing a dissolved reagent into the interior volume of the capsule; applying a sealing film to the second surface of the main body to enclose the dissolve reagent within the interior volume, thereby forming a capsule competent for reagent drying; drying the dissolved reagent in the capsule to remove solvent from the reagent, thereby filling the interior volume with a dried reagent; and applying a capping film to the porous membrane to isolate the dried reagent from an outside environment.

In some embodiments, the steps of drying the dissolved reagent and applying the capping film are both performed inside a drying chamber. In some embodiments, drying the dissolved reagent comprises lyophilizing the dissolved reagent in a lyophilization chamber, wherein the dried reagent is a lyophilized reagent.

Also provided herein is a method of preparing a dried reagent, comprising providing a module comprising an array of a plurality of capsules; dispensing a dissolved reagent into one of the plurality of capsules; drying the dissolved reagent in the capsule to remove solvent from the reagent, thereby filling the interior volume with a dried reagent; and closing the vent in the cap so that the cap is in the closed position, thereby isolating the dried reagent from an outside environment.

In some embodiments, drying the dissolved reagent and closing the vent is performed inside a drying chamber. In some embodiments, drying the dissolved reagent comprises lyophilizing the dissolved reagent in a lyophilization chamber. In some embodiments, the dried reagent is a lyophilized reagent.

Also provided herein is a method of providing a dried reagent to a microfluidic device, comprising: providing a reagent storage component from an array of reagent storage components, wherein said reagent storage component comprises a capsule comprising a dried reagent; removing the reagent storage component from the array; and mounting the reagent storage component on to an oval-shaped raised surface of a microfluidic device to form a fluid-tight engagement between said reagent storage component and said microfluidic device, wherein the oval-shaped raised surface comprises an inlet and an outlet.

In some embodiments, the method of providing a dried reagent to a microfluidic device further comprises flowing a solvent from the inlet into the capsule to reconstitute the dried reagent. In some embodiments, the method further comprises mixing the dried reagent in the solvent using a mixing element contained in the capsule.

Also provided herein is a method of rehydrating a dried reagent, comprising providing a reagent storage component comprising a main body comprising a first surface, a second surface, and a capsule comprising first and second flow-through ports and an interconnecting channel; flowing a rehydrating fluid into an opening of the first or second surface of the main body into said first flow-through port, wherein said rehydrating fluid flows from said first flow-through port to said second flow-through port through said interconnecting channel, wherein said rehydrating fluid dissolves said dried reagent, and wherein said rehydrating fluid comprising said dissolved reagent flows out of said capsules via the opening at of the first or second surface for the first flow-through port or the second flow-through port.

In some embodiments, the rehydrating fluid flows into and out of the capsule through the permeable layer. In some embodiments, the permeable or impermeable seal is removed or broken to allow flow of the rehydrating fluid into and out of the capsule.

In some embodiments, the rehydrating fluid flows into and out of the capsule through the first or second flow-through port opening at the first surface.

In some embodiments, the rehydrating fluid flows into and out of the capsule through the first or second flow-through port opening at the second surface.

In some embodiments, the rehydrating fluid flows into the first flow-through port via the opening at said first surface and out of said second flow-through port via the opening at said second surface, or flows into said first flow-through port via the opening at said second surface and out of said second flow-through port via the opening at said first surface.

Also provided herein is a method of rehydrating a dried reagent, comprising providing a reagent storage component comprising a main body comprising a first surface, a second surface, and a capsule comprising first and second flow-through ports and an interconnecting channel; and flowing a rehydrating fluid into an opening of said first flow-through port at the first or second surface, wherein said rehydrating fluid flows from said first flow-through port to said second flow-through port through said interconnecting channel, wherein said rehydrating fluid dissolves said dried reagent, and wherein said rehydrating fluid comprising said dissolved reagent flows out of said capsules via the opening at the first or second surface of the second flow-through port.

Also provided herein is a method of rehydrating a dried reagent, comprising: providing a reagent storage component comprising a capsule; flowing a rehydrating fluid into the capsule, thereby dissolving the dried reagent; and flowing the rehydrating fluid comprising the dissolved reagent out of the capsule through the inlet.

Also provided herein is a method of rehydrating a dried reagent, comprising providing a module comprising a reagent storage component comprising a capsule, wherein the capsule comprises a dried reagent; removing the reagent storage component from the module; flowing a rehydrating fluid into the capsule, thereby dissolving the dried reagent; and flowing the rehydrating fluid comprising the dissolved reagent out of the capsule.

In some embodiments, the method of rehydrating a dried reagent comprises mixing the dried reagent and the rehydrating fluid. In some embodiments, the capsule comprises a magnetic mixing element, and wherein the method further comprises moving the magnetic mixing element to facilitate rapid mixing of the rehydrating fluid and the dried reagent. In some embodiments, the method of rehydrating a dried reagent further comprises separating the reagent storage component from an array of reagent storage components.

In some embodiments, the method further comprises attaching the reagent storage component to a microfluidic device comprising an inlet and an outlet, wherein the inlet and the outlet are in fluid communication with the interior of the capsule when the reagent storage component is attached to the microfluidic device. In some embodiments, rehydrating fluid flows into the capsule via the inlet, and wherein the rehydrating fluid flows out of the capsule via the inlet or the outlet.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead placed upon illustrating the principles of various embodiments of the invention.

FIG. 1 illustrates a cross-section view of a fully assembled reagent storage component including a capsule with two through-ports and an interconnecting channel, plus top and bottom membrane seals, according to one embodiment of the invention.

FIG. 2 illustrates several views of another embodiment of a reagent storage component, including a top-down view, an angled view, and a transparent line drawing to show the configuration of the internal surface of the capsule of the reagent storage component

FIG. 3 provides an illustration of a top view and side view of an embodiment of a capsule comprising an oval opening and concave-shaped bottom with an optional baffle to separate the capsule into two compartments (e.g., flow-through ports).

FIG. 4 provides an illustration of an embodiment of an interface unit configured to adapt a capsule opening to form a tight seal indirectly with a cap.

FIG. 5A shows an embodiment of reagent rehydration in a capsule in fluidic communication with an assay device.

FIG. 5B shows an embodiment of a capsule with a porous membrane seal applied to one end of the capsule, and an impermeable capping film applied to the other end of the capsule after it is filled with reagent.

FIG. 6 provides a wireframe drawing of an embodiment of an interface for attaching a microfluidic device to a capsule to allow rehydration and delivery of a dried reagent.

FIG. 7 illustrates a sheet of capsule main bodies suitable for molding and subsequent singulation for manufacturing and packaging into a consumable device.

FIGS. 8A and 8B illustrates a top view (FIG. 8A) and a bottom view (FIG. 8B) of an embodiment of a sheet of capsule main bodies, in which the sheet illustrates three separate main body designs.

FIG. 9 illustrates a sheet of capsules each comprising an oval-shaped opening, according to an embodiment of the invention.

FIG. 10 depicts an array of capsules with a pressure-sensitive adhesive film applied to the bottom of the capsules.

FIG. 11 illustrates the materials and process for filling capsules with reagent and applying the porous membrane to the array using a porous membrane press plate, according to an embodiment of the invention.

FIG. 12 provides two blown up angled views of an exemplary configuration of an array of capsules and a capping film held in a press tool before insertion into a drying chamber.

FIG. 13 shows a side view of an exemplary configuration of an array of capsules and a capping film held in a press tool before insertion into a drying chamber.

FIGS. 14A and 14B provide a bottom view and a blown up view, respectively, of an embodiment of a press tool which is used in a drying chamber to apply a seal to a capsule array after drying is complete.

FIG. 15 depicts an exemplary embodiment of reel to reel sealing to prepare for reagent drying.

FIG. 16 depicts an example of sealing an array of capsules with an array of caps, including an array of interface units to provide a seal between each cap and each capsule.

FIG. 17 depicts the use of nest trays to hold an array of capsules and interface units, as well as edge and corner clips to hold the arrays together, according to an embodiment of the invention.

FIG. 18 illustrates the use of a nest tray to hold an array of capsules, and the removal of a nest tray to facilitate removal of a capsule while the array of capsules is held in place by an array of interface units or caps, according to an embodiment of the invention.

FIG. 19 illustrates an exemplary use of a vacuum pick and place tool to remove a single capsule from an array of capsules.

### DETAILED DESCRIPTION

The details of various embodiments of the invention are set forth in the description below. Other features, objects, and advantages of the invention will be apparent from the description and the drawings, and from the claims.

### Definitions

As used herein, the term “permeable membrane” or “permeable layer” refers to a vapor permeable layer. In this context, the permeable membrane is applied over the top of a capsule to mitigate spillage of a reagent contained in the capsule during handling and drying, while still allowing the capsule to be exposed to air to facilitate drying to form a dried reagent in the capsule.

As used herein, the term “impermeable membrane” or “impermeable layer” refers to a vapor impermeable layer. In some embodiments, the impermeable layer can be used to form a seal across an opening of a capsule. This seal can be used to form a bottom of a capsule to facilitate holding a solution or a dried reagent. This seal can also be used to seal the top of a capsule to avoid humidity damage or other contamination or reagent loss after drying.

It will be recognized that the words “top”, “bottom”, “upper”, “lower”, “side”, “roof”, “floor”, and “base” as used here are relative terms and do not necessarily describe the orientation of the device or device components in relation to the plane of the earth's surface unless explicitly stated to be so. The preferred use of the devices flat on the surface of a table is not intended to be limiting and the z-axis is generally chosen to be perpendicular to the major plane of the device body only as a matter of convenience in explanation and manufacture.

As used herein, the term “affixed” or “attached” includes the physical connection of two or more components of a device. This includes two components that are part of a continuous mold or other continuous material, but can also include two components originally of a discontinuous material that are bonded, welded, or otherwise physically connected together in a manner that is resistant to separation.

As used herein, the term “microfluidic device” or “microfluidic cartridge” generally refers to a device through which materials, particularly fluid borne materials, such as liquids, can be transported, in some embodiments on a micro-scale, and in some embodiments on a nano-scale. Thus, the microfluidic devices described by the presently disclosed subject matter can include microscale features, nanoscale features, and/or combinations thereof.

Accordingly, a microfluidic device typically includes structural or functional features dimensioned on the order of a millimeter-scale or less, which are capable of manipulating a fluid at a flow rate on the order of a microliter/min or less. Typically, such features include, but are not limited to channels, fluid reservoirs, reaction chambers, mixing chambers, and separation regions. In some examples, the channels include at least one cross-sectional dimension that is in a range of from about 0.1 μm to about 500 μm. The use of dimensions on this order allows the incorporation of a greater number of channels in a smaller area, and utilizes smaller volumes of fluids.

A microfluidic device can exist alone or can be a part of a microfluidic system which, for example and without limitation, can include: pumps for introducing fluids, e.g., samples, reagents, buffers and the like, into the system and/or through the system; detection equipment or systems; reagent, product or data storage systems; and control systems for controlling fluid transport and/or direction within the device, monitoring and controlling environmental conditions to which fluids in the device are subjected, e.g., temperature, current, and the like.

By a “microfluidic” structure is meant a structure having at least one feature that is 1,000 μm or less in at least one dimension. Exemplary features include a layer (e.g., the thickness of a layer or the length, width, or height of a component embedded within a layer), a chamber (e.g., a well, a channel, a hole, a duct, a bridge, or a cavity), a membrane (e.g., the thickness of a membrane or the length, width, or height of a component (e.g., one or more pores or other physical structures) embedded within a membrane), or a capture region. In some embodiments, the structure includes more than one, two, three, four, five, six, seven, eight, nine, ten, twenty, or more features that are 1,000 μm or less in at least one dimension (e.g., height, width, depth, or thickness).

As used herein, the term “oval” refers to a shape that is generally rounded with no sharp faces, and on average has a longer width or length compared to the other. This can be in the typical shape of an egg, or an ellipse with a minor and major axis not equal to each other. Ovals are not circles, which have a constant circumference such that their width and length that are equal to each other. An ovoid is a 3-dimensional structure or surface with an oval-shaped planar cross-section. For example, an egg is an example of an ovoid-shaped object.

By “fluidic communication” is meant the state of being able to pass a liquid or gas from one fluidic element (i.e., a structure to hold, carry, or allow transport of a fluid) to another fluidic element. Fluidic communication can occur by any physical process, including diffusion across a membrane, active transport, or passive transport. A connection between fluidic elements to cause them to be in fluidic communication can be via a channel, passageway, pathway, conduit, flow path or other fluidic element.

The term “layer” refers to any of one or more generally planar solid substrate members.

Devices

This disclosure describes a simple, low-cost capsule container capable of holding reagents, such as proteins or nucleic acids, during a process of preparing a dried reagent and actively applying a capping film or other capping mechanism for sealing before extracting the capsule from a closed drying environment into the ambient environment. The cap film seal or capping mechanism ensures hermetic protection of the in situ dried reagent during long term storage.

The compact capsule design provides efficient space utilization and low unit cost processing. The capsule is injection molded and can be produced in large arrays or monolithic sheets with webbing or other interconnect to facilitate manual or automated processing, including robotic liquid dispensing, pick & place automated handling, plate sealing, dicing or singulation technologies that are commercially available.

The capsule design concept can be configured in a number of ways to integrate into custom assay processing instruments or devices for applications including medical diagnostics, clinical lab testing and environmental monitoring. In this manner, a dried reagent does not have to be removed from the capsule it was originally dried in, which can be a slow process subject to contamination and loss of reagent. The sealed capsules of dried reagents are stable and designed for long storage shelf life which would allow for lower manufacturing and inventory costs.

The capsule is preferably shaped in such a way that it can be connected to a channel network of a microfluidic device to allow flow of a solvent through the capsule, thus permitting rehydration of the dry reagent, which then can be passed to other portions of the microfluidic device. The internal capsule surface is shaped and/or textured to enable efficient rehydration.

In some embodiments, provided herein are capsules that facilitate in situ reagent drying in a high throughput reagent drying processes, long term storage in the capsule (alone or integrated into a microfluidic device or other custom assay device), automated reagent mixing in the capsule for rapid homogenous rehydration, and automated delivery of the rehydrated reagent to a custom assay device, such as a microfluidic cartridge.

Capsule

In some embodiments, the capsule construction simply involves a series of laminations mounted using adhesive materials including a hydrophobic porous membrane that would enable freeze drying evaporation but also prevent spill or splash out. In addition, the porous membrane is designed for low pressure flow through during the rehydration and assay process.

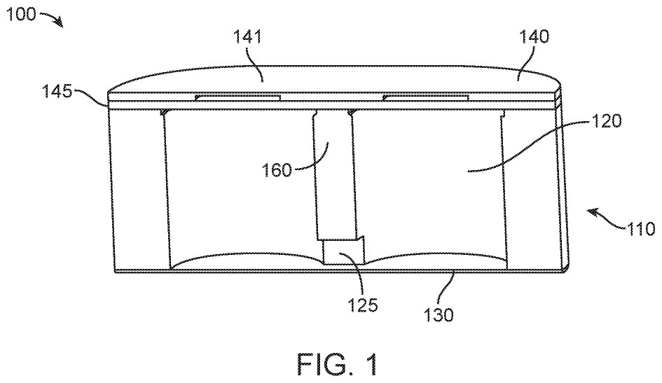

FIG. 1 illustrates a cross-section view of a fully assembled reagent storage component 100, including a capsule 110, according to one embodiment of the invention. The main body of the capsule 110 comprises two flow-through ports 120 extending from a first surface to second surface of the main body. The flow-through ports are connected to allow fluid flow between the flow-through ports by an interconnecting channel 125 at the second surface of the main body. An impermeable sealing film 130 can be affixed to the bottom (second surface) of the capsule to provide a bottom surface for each of the flow-through ports. A permeable porous membrane 145 can be affixed to the top (first surface) of the capsule to provide a barrier to prevent leakage from the flow-through ports while still allowing air flow for evaporation, lyophilization, or other drying mechanisms. After drying, an impermeable capping film 140 can be applied to the top of the porous membrane, or directly to the top (first surface) of the capsule.

In one embodiment, the reagent storage component comprises a sealing film 130 affixed to the second surface of the capsule 100 to seal the opening of each flow-through port at the second surface, thereby providing a bottom to the capsule to allow the capsule to hold a liquid or dried reagent. The sealing film 130 also provides a bottom barrier to form the interconnecting channel 125 without obstructing passage of material between the ports 120.

In other embodiments, the capsule bottom is formed as part of a single mold of the capsule. The bottom of the capsule can be formed into a concave shape to reduce or remove the presence of corners or edges in the capsule to provide a substantially smooth surface on the interior of the capsule.

When fully assembled for drying, the reagent storage component can also comprise a permeable membrane, such as a porous membrane 145 attached to the first surface of the capsule 110, thereby separating the ports from the outside environment. In this embodiment, a reagent solution is preferably placed into the interior of the capsule before the porous membrane 145 is applied. The porous membrane can be affixed to the surface of the main body or can be molded into the main body. Finally, a capping film 140 is applied to the porous membrane. Preferably, the top capping film is patterned with non-adhesive areas 141 at the entrances to the through ports.

In some embodiments, the porous membrane 145 and/or capping film 140 can be attached to the first surface of the capsule 110 before addition of a reagent, followed by application of the sealing film 130 to the second surface of the capsule 110 to isolate a reagent that has been dried or otherwise prepared for storage from the external environment. In other embodiments, the sealing film 130 can be attached to the second surface before addition of a reagent, followed by application of the porous membrane 145, then application of the capping film 140 to isolate a reagent that has been dried or otherwise prepared for storage from the external environment.

The reagent storage component shown in FIG. 1 is fully assembled for storage and delivery of a dried reagent to a microfluidic device. An impermeable sealing film 130 is attached to the second surface of the capsule 110 to seal the opening of each flow-through port at the second surface, a permeable porous membrane 145 is attached to the first surface of the capsule 110 to cover the opening of each flow-through port 120 at the first surface, and an impermeable capping film 140 is affixed to the sealing film 145 or the first surface, thereby creating a sealed environment within the capsule.

In some embodiments, the impermeable film affixed to the capsule, such as the sealing film or capping film is frangible to facilitate flow of rehydrating fluid into the capsule. In some embodiments, the capping film comprises patterned non-adhesive areas 141 over the top of each flow-through port.

In other implementations, the interconnecting channel can located at the first surface or separated from both surfaces to optimize flow for rehydration and mixing of a dried reagent. This location can also depend on whether the rehydrating fluid comes from the first surface or the second surface, and whether it exits through the first surface or the second surface.

In one exemplary implementation, the combined volume of the through ports and interconnecting channel is approximately 260 μL.

In some embodiments, the interconnecting channel is at the bottom of the ports adjacent to a bottom seal. In some embodiments, the interconnecting channel is at the top of the ports adjacent to a top seal. In some embodiments, the interconnecting channel is at the middle of the ports, and not adjacent to either the top or bottom seal.

In some embodiments, the interconnecting channel is a direct connect (as shown in FIG. 1), a spiral, or serpentine. Longer, smaller channels may be more conducive for certain applications.

In some embodiments, inlet/outlet port locations can be located on either plane of the device, or on both. In some embodiments, the capsule can be sandwiched between two fluidic devices. In some embodiments, the bottom of capsule can be molded part of the capsule, does not have to be a separate seal.

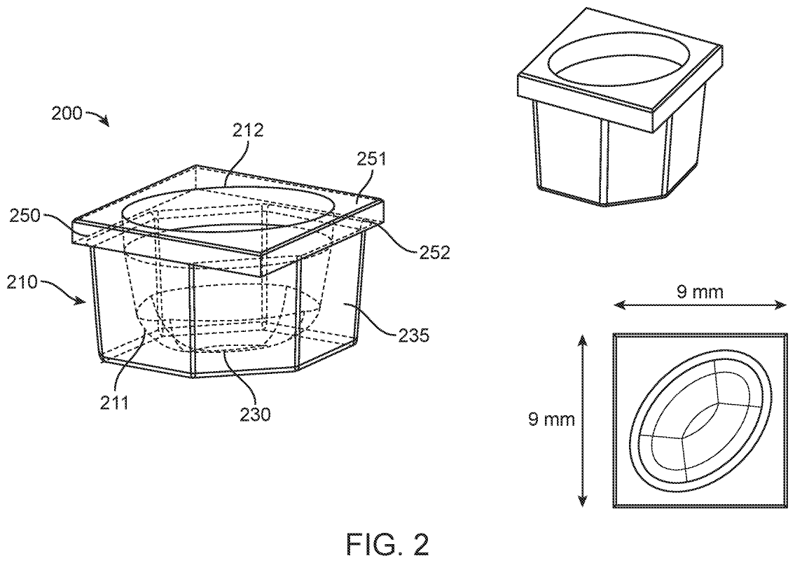

Another embodiment of a reagent storage component is shown in FIG. 2, illustrating several views of the reagent storage component, including a top-down view, an angled view, and a transparent line drawing to show the configuration of the internal surface of the capsule of the reagent storage component. The reagent storage component 200 includes a capsule 210 with an interior surface that may vary in size and configuration but typically has a substantially smooth surface to facilitate efficient rehydration by minimizing corners and sharp edges that could give rise to mixing dead zones or trap bubbles.

The capsule includes an oval-shaped opening 212, a closed end at the bottom of the capsule 230, and a wall 235 extending from the closed end to the opening 212. The interior surface 211 of the capsule is rounded to provide a substantially smooth surface on the interior of the capsule. In some embodiments, the interior surface 211 of the capsule includes a concave shape extending from the bottom 230 of the capsule. In some embodiments, the wall 235 and the bottom 230 of the capsule is formed from the same molded body.

In some embodiments, the interior depth of the capsule from the opening to the bottom is approximately 5.75 mm. In some embodiments, the interior depth of the capsule from the opening to the bottom is between 5-8 mm. In some embodiments, the height of the capsule from the external bottom to the top of the capsule is approximately 6 mm. In some embodiments, the height of the capsule from the external bottom to the top of the capsule is between 5-9 mm.

The volume of the capsule as defined by the interior surface and oval-shaped opening can range from approximately 50 μl to approximately 200 and preferably is approximately 170-190 μL.

In some embodiments, the reagent storage component also includes a planar layer 250 affixed around the capsule. The planar layer includes a top surface 251 and a bottom surface 252. This planar layer can facilitate handling or situating the capsule in an array of capsules, e.g., by connecting the planar layer of multiple capsules, or by resting the bottom surface 252 into a slot of a nesting layer capable of holding multiple capsules. In some embodiments, as illustrated in FIG. 2, the planar layer 250 is affixed around the oval-shaped opening of the capsule. Here, the planar layer 250 is oriented in the same plane as the oval-shaped opening 212 of the capsule 210, and is aligned with the inner surface 211 of the capsule at the oval-shaped opening to provide a continuous (i.e., unbroken) surface.

The planar layer can be affixed to the capsule as part of the same mold as the capsule, or can be welded, adhesively bonded or otherwise attached to the part of the same mold as the capsule, or be affixed to the capsule. The planar layer projects outwardly from the capsule, such that it can serve as a gripping part for facilitating manual handling or automated assembly.

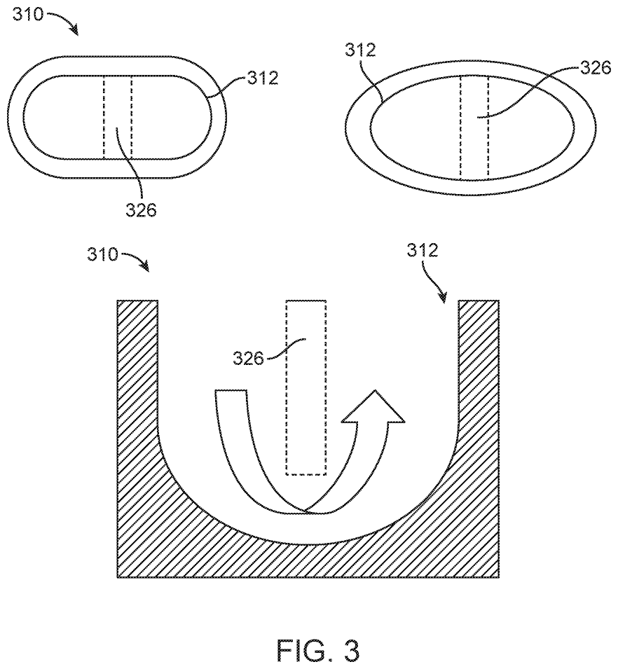

The interior of the capsule can also include a baffle that separates the interior of the capsule into two compartments with an interconnecting channel, similar to the embodiment as shown in FIG. 1. The baffle can be molded as part of the capsule, or can be bonded, secured, or otherwise attached to the capsule. An illustration of a top view and side view of a capsule comprising an oval opening and concave-shaped bottom with a baffle to separate the capsule into two compartments is shown in FIG. 3. The capsule 310 comprises a baffle 326 attached to the inner surface of the capsule. The baffle 326 includes an interconnecting channel at the bottom of the capsule to allow liquid to flow (blue arrow) from one part of the capsule to another, as in the embodiment shown in FIG. 1. Two different embodiments of an oval-shaped opening 312 are also shown in FIG. 3.

In some embodiments, the wall of the capsule is thin to allow for efficient conductivity within a drying chamber.

The opening of the capsule can be sealed as described above, e.g., by applying a porous film to the top of the opening of the capsule to allow venting during lyophilization or other drying mechanisms, and/or by applying an impermeable film to seal the capsule. This film can bond to the top layer of the planar layer of the reagent storage component so that the layer encloses the capsule by covering the opening. Preferably, the impermeable film is applied in the drying chamber after the reagent is dried to minimize contamination from the ambient environment and reagent loss.

In some embodiments, the capsules described herein may be sealed by a cap that covers the opening of the capsule. In some embodiments, the cap can be pressed down into the capsule to form a tight seal. In another embodiment, the cap can be screwed into the opening.

In some embodiments, the capsules may be sealed by a cap that provides a venting mechanism which can be opened to allow vapor to pass through the cap, and closed to provide a sealed environment. These caps are known in the art. For example, in U.S. Publication No. 2005/0086830, “Processing cap assembly for isolating contents of a container,” incorporated by reference in its entirety for its disclosure of a venting cap, a cap assembly for venting and isolating a container during processes such as freeze-drying, foam-drying, and other forms of evaporative, sublimation, or desorption drying is disclosed. The cap is designed to isolate the contents of the capsule, both from contamination and from loss of material, while allowing a path for vapor exchange between the capsule and an external atmosphere during processing.

In another embodiment, in U.S. Pat. No. 3,454,178 to Bender, et al., the disclosure of which is incorporated by reference for its disclosure of a venting cap, a vial contains a slotted vial cap that, when in the “open” position, allows a path for water vapor to escape the vial. Vials are introduced into the process with their caps in the “open” position, and remain that way until the drying cycle is complete. At the end of the cycle, freeze-drier shelves squeeze down on the vials and press the caps into the “closed” position, thus sealing the vials before the freeze-drier door is opened. This approach insures that contents of the vials are not contaminated after the process is completed. It also assures that water vapor cannot enter the vials and rehydrate the product once the freeze-drier doors are opened

In another embodiment, as taught by U.S. Pat. No. 5,522,155, the disclosure of which is incorporated by reference, a vial cap is taught which incorporates a controllable venting port protected by a venting media. The porous venting media is located in the venting path created between the cap and the vial, and the media provides a barrier to bacteria and other particulate contamination, while permitting the passage of gases such as air and water vapor.

In some embodiments, Micronic TPE Lyo Caps-96™ are used for sealing capsules, and can be provided in a 96-well tube format. The caps are specially developed for a drying process as the vents in the caps allow water vapor to escape from capsules, such as tubes or microtiter plates.

In some embodiments, the caps have a circular interface which does not match the oval-opening of some of the capsules provided herein. Thus, also provided herein are interface units which have a top surface that forms a seal with a circular vented cap, and a bottom surface that forms a seal with an oval-shaped opening of a capsule. The interface units have a through hole so that the capsule may be vented through the interface unit to the cap, which may be vented during drying or closed to provide a sealed environment for the capsule.

The interface unit may vary in size and configuration, but will be specifically designed to form a tight seal between the interface unit and the capsule, and a tight seal between the interface unit and the cap, with a through hole located in the interface unit to align the interior volumes of the cap and the capsule, thereby indirectly mounting the cap on the opening of the capsule. In some embodiments, the tight seal is a fluid-tight or airtight engagement.

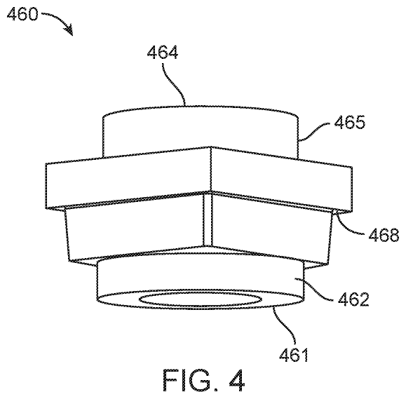

One embodiment of an interface unit 460 is shown in FIG. 4. As shown, the interface unit comprises a bottom oval-shaped lower engaging member 461 with an edge 462 that tapers down toward the capsule as the interior of the capsule becomes narrower. In particular, it is therefore possible, simply by pressing the interface unit mechanically into the opening of the capsule, to achieve a tight seal between the interface unit and the capsule in the manner of a press-fit. In some embodiments, the lower engaging member is elliptical. The interface unit 460 also comprises a top circular-shaped upper engaging member 464 that comprises an edge 465 that tapers up toward the circular cap. It is therefore possible, simply by pressing the interface unit mechanically into the opening of the cap, to achieve a tight seal between the interface unit and the cap in the manner of a press-fit. One of ordinary skill in the art will recognize that the upper engaging member need not be circular and can adopt an appropriate shape to accommodate a cap of any shape.

In some embodiments, a similar engagement may be achieved through an interface unit and a cap by pressing the cap into a circular opening at the top of the interface unit, such that a press-fit seal is achieved. In some embodiments, the cap may screw on to or into the interface unit to achieve a fluid tight engagement.

In some embodiments, the interface unit is configured to have a ledge on the outer surface to engage a slot for insertion of the interface unit, such as in a nesting array configured to hold a plurality of interface units aligned with a plurality of capsules and caps. For example, the interface unit shown in FIG. 3 has a square-shaped ledge 468 that can be inserted into and rest upon a square-shaped slot in a nesting array.

Sealing

Provided herein are seals that facilitate reagent drying in a capsule, reagent storage in a capsule, and reagent rehydration in a capsule for delivery to a microfluidic device. These seals can be used with any capsule described herein. In some embodiments, the seal is a film adhesively bonded a top or bottom opening of a capsule to achieve leak-tightness. This seal may be formed by mechanically pressing the seal into the capsule or on to a surface at the capsule opening.

In some embodiments, the seal is a cap or vented cap that directly or indirectly mounts to the opening of a capsule to form a fluid-tight or air-tight engagement with the opening of a capsule.

In some embodiments, the seal is impermeable, such as an impermeable film or an impermeable cap. An impermeable seal can be applied to any opening of a capsule, such as at a top opening or a bottom opening. In preferred embodiments, the impermeable seal prevents air or liquid from entering or exiting the capsule at the sealed opening. An impermeable seal can be used to provide a bottom surface for a capsule to contain a liquid reagent in a capsule while still having an open top. An impermeable seal can be used to seal all openings of a capsule, thereby providing an isolated environment within the capsule for long term storage of a dried reagent. The impermeable seal prevents exposure of the dried reagent to humidity or other ambient exposure. In this manner, the impermeable seal can increase the shelf stability of a reagent, such as proteins. As described herein, sealing films and capping films refer to impermeable seals.

In some embodiments, the seal is a permeable, such as a porous membrane or vented cap. In some embodiments, the vented cap comprises a porous membrane across the vent. Preferably, the permeable seal is vapor permeable to facilitate drying of a reagent dissolved in a solvent and contained within a capsule, while preventing contamination of the reagent or reagent loss during drying. The porous membrane can also act as a barrier to minimize splattering or bumping during the drying process. In some embodiments, the porous membrane prevents buffer from flowing through the membrane unless sufficient pressure is applied to force the buffer through the porous membrane. In some embodiments, the membrane provides some protection from evaporation but at some threshold pressure would allow the buffer to flow through.

A porous membrane can be retained to cover the opening of the capsule during reagent flow in or out of the capsule to remove air bubbles from a liquid reagent, which may interfere with downstream processing or activity of the liquid reagent.

In some embodiments, the porous membrane is hydrophobic in order to prevent aqueous flow entirely. In this embodiment, reagent is inserted into the capsule before application of a hydrophobic porous membrane. A hydrophobic membrane can act as a seal at the bottom or the top of the capsule to hold in the liquid reagent. Thus, a hydrophobic membrane can be used as a bottom layer (opposite the open end of the capsule) for a capsule during reagent filling, reagent drying, and/or reagent rehydration.

In some embodiments the permeable or impermeable seal affixed to the capsule is frangible or pierceable to facilitate rehydration or other fluid flow after storage. The frangible or pierceable seal can be affixed at any opening of the capsule, including the top or bottom of the capsule. The frangible seal refers to a seal that is brittle or fragile such that it may be broken by the application of sufficient air or liquid pressure to the seal, or by application of mechanical force, as in a piercing of the seal. In some embodiments, liquid pressure can break the frangible seal at an inlet channel attached to the capsule, then provide sufficient pressure to break the frangible seal at the vent or outlet channel attached to the capsule. A pierceable seal refers to a seal that has properties to facilitate mechanical penetration to break the seal, such as by insertion of a pin.

In some embodiments, the frangible seal or pierceable seal is located at an opening of the capsule that is not adjacent to the interconnecting channel between two through-ports to facilitate reagent rehydration and mixing. In some embodiments, the frangible seal or pierceable seal is located at an opening of the capsule that is adjacent to the interconnecting channel between two through-ports to facilitate reagent rehydration and mixing.

In some embodiments, the seal is removable to facilitate rehydration after storage.

In some embodiments, the permeable or impermeable seals described herein have a pressure sensitive adhesive to bond the seal to a surface at the opening of a capsule. In some embodiments, the permeable or impermeable seals described herein have a thermally sensitive adhesive to bond the seal to a surface at the opening of a capsule. In some embodiments, the permeable or impermeable seals described herein have a UV sensitive adhesive to bond the seal to a surface at the opening of a capsule. In some embodiments, the permeable or impermeable seals described herein are welded to the capsule. In some embodiments, the permeable or impermeable seals described herein are laser molded to the capsule using a pulse laser.

In some embodiments, the permeable or impermeable seals described herein are caps. The caps can be pushed into a capsule body to form a press-fit seal with the capsule. In preferred embodiments, the wall of the capsule narrows from the opening of the capsule toward the bottom to facilitate formation of a seal directly with the cap. In some embodiments, the cap forms a seal indirectly with a capsule through an interface unit. In some embodiments, a cap may be threaded to engage with an opening of a capsule or an interface unit by screwing the cap into or onto the capsule or interface unit.

In some embodiments, the seal is fluorimetric or colorimetric to facilitate monitoring of a signal from the reagent contained in the capsule. This may be to determine the quality of the stored reagent, or as part of a custom assay upon rehydration of the reagent. Thus, in some embodiments, the rehydrated reagent does not need to exit the capsule to provide the results of a custom assay.

Rehydration and Mixing

Another feature of the capsules of the present invention is that they are designed to enable efficient rehydration of a dried reagent in a rehydrating fluid, which can then be delivered to a microfluidic device. In microfluidic applications, rapid mixing of the dried reagent into a homogenous, well-mixed solution is necessary to ensure repeatability of results, and to minimize false negatives or false positives by providing a consistent, uniform concentration of a dissolved reagent for applications in the capsule or downstream in a microfluidic device.

In one embodiment, the capsule comprises an interconnecting channel between two compartments (e.g., flow-through ports) in a capsule, with an inlet connected to one compartment, and a vent or outlet connected to the other compartment. In this manner, a solvent for rehydration (i.e., a rehydrating fluid) of the dried reagent in the capsule can be flowed into one compartment (e.g., a first flow-through port), through the interconnecting channel and into the other compartment (e.g., a second flow-through port). The interconnecting channel facilitates directed flow to increase the efficiency of rehydration. The flow of the fluid can also be reversed to facilitate mixing by moving the solvent back and forth through the interconnecting channel and compartments (e.g., flow-through ports) of the capsule. In some embodiments, the outlet relieves pressure due to influx of the rehydrating fluid (e.g., as a vent). In some embodiments, fluid may be shuttled back and forth within the capsule to rehydrate, but can exit the capsule through the same orifice as the solvent originally entered (i.e., the inlet). For example, a valve may be switched downstream of the inlet to deliver the rehydrated regent to a processing chamber elsewhere in the device.

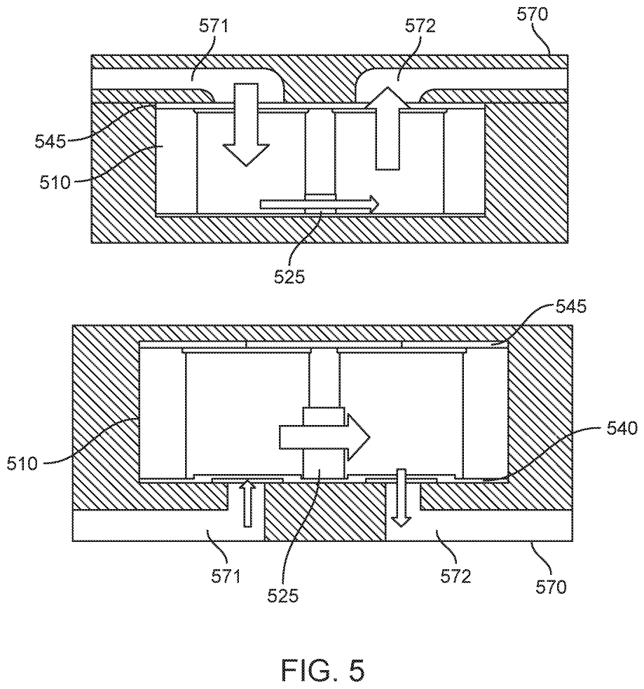

FIG. 5A shows an embodiment of reagent rehydration in a capsule in fluidic communication with an assay device. In this embodiment, the capping film is removed before installing the capsule in an assay device. The arrows show the direction of a fluidic flow path for rehydration, with fluid coming from an inlet 571 from the assay device 570, through a porous membrane 545, where it enters into the capsule volume filled with dried reagent. The fluid flows into the first flow-through port, through the interconnecting channel to the second flow-through port. The fluid exits through the outlet 572 where fluid comprising the rehydrated reagent can enter back into the assay device 570 or go into another device.

Instead of removing the seal prior to introduction of fluid for rehydration, a seal may be broken to allow fluid to flow into and out of the capsule for reagent rehydration. For example, in FIG. 5B, a capsule is illustrated with a hydrophobic porous membrane seal 545 applied to one end of a capsule, and an impermeable capping film 540 applied to the other end of the capsule after it is filled with reagent. The capping seal is frangible or pierceable. The hydrophobic porous membrane permits vapor to pass through during reagent drying, but contains the reagent within the capsule. In some embodiments, the porous membrane further has an impermeable capping film applied after the reagent is dried. To rehydrate, the frangible seal or pierceable seal 540 would be punctured or otherwise broken to introduce fluid opposite from the porous membrane from an inlet 571, through an interconnecting channel 525. Fluid goes through and stops at the hydrophobic porous membrane 545 on top of other capsule, then can push back through frangible seal capping seal 540 to vent the capsule and/or flow the rehydrated reagent into the outlet channel 572 and into the microfluidic device 570.

In some embodiments, the capsule can comprise a baffle that separates a capsule described herein into two compartments (e.g., ports), where the baffle has an interconnecting channel that allows fluid to flow from one compartment to another, e.g., in the manner shown in FIG. 5A or FIG. 5B. In some embodiments, the flow can be reversed to facilitate mixing of the dried reagent.

In some embodiments, agitation is used to facilitate rapid mixing in a capsule. For example, in some embodiments, the capsule comprises a mixing element, such as a magnetic bead, that can be moved within the capsule to generate agitation. This can facilitate rapid mixing of dried reagents that are more difficult to rehydrate.

In some embodiments, the surface of the capsule is substantially smooth to minimize the presence of bubbles. In a preferred embodiment with a substantially smooth surface, the capsule is oval-shaped with a concave surface extending from the bottom of the capsule.

In some embodiments, the capsule comprises both an interconnecting channel and a mixing element, such as a magnetic bead, such that mixing can be achieved both through the flow of the rehydrating solvent through the capsule and by agitation by a mixing element.

The capsule comprising the dried reagent can be attached to a source of rehydrating fluid, such as a microfluidic device in a number of ways envisioned by one of ordinary skill in the art. This assembly step introduces the capsule containing the dried isolated reagent to a microfluidic device. To this end, a dried reagent is mixed and reconstituted with a rehydrating fluid before being delivered to a microfluidic device.

In this embodiment, an inlet channel is defined in the microfluidic device which facilitates the flow of a rehydrating fluid from a source to the capsule. An outlet channel can also be defined in the microfluidic device. In some embodiments, the outlet channel facilitates flow of the rehydrated sample from the capsule into a microfluidic device for downstream processing. The outlet channel can also serve to relieve pressure due to the influx of rehydrating fluid into the capsule. In some embodiments, fluid may be shuttled back and forth within the capsule to actively rehydrate, and the rehydrated reagent can exit the capsule through the inlet (i.e., the same orifice as the rehydrating reagent originally entered) or the outlet. This type of inline flow through the capsule is an alternative embodiment to passing a rehydrating solution above the top of a capsule attached to a microfluidic device to passively rehydrate, which generally requires more time and is not as effective at creating a homogeneous rehydrated solution, especially for dried reagents that are more difficult to rehydrate.

When the rehydrated reagent passes into the microfluidic device through the inlet (instead of the outlet), the fluidic path may be altered to pass the rehydrated reagent to a different area of the microfluidic device as the source of the rehydrating fluid. For example, the rehydrated reagent can pass through the inlet and into a valve that is now in a different position to deliver the rehydrated reagent to a processing chamber elsewhere in the device.

The inlet and outlet ports in the microfluidic device are defined such that, when the capsule is attached to the microfluidic device, they are in fluid communication with the capsule. They can be fully contained within the microfluidic device, where a surface comprising the inlet and outlet channels is inserted into the capsule. The can also extend from the microfluidic device into the capsule, which can be useful for puncturing a seal attached to the capsule.

The capsule reagent can also be simply rehydrated and delivered for the assay device by interfacing fluidic paths with the two port openings on the capsule. Flow through is possible to another holding chamber in the assay device or bi-directional flow can be used to ensure complete rehydration and mixing. The custom design of the capsule and its interface to the assay device enables various ways to drive the rehydration fluid through the capsule. If sufficient, pressure can drive the fluid through the porous membrane on the capsule. Alternatively, a piercing feature in the assay device can directly create a flow path through the capsule membrane.

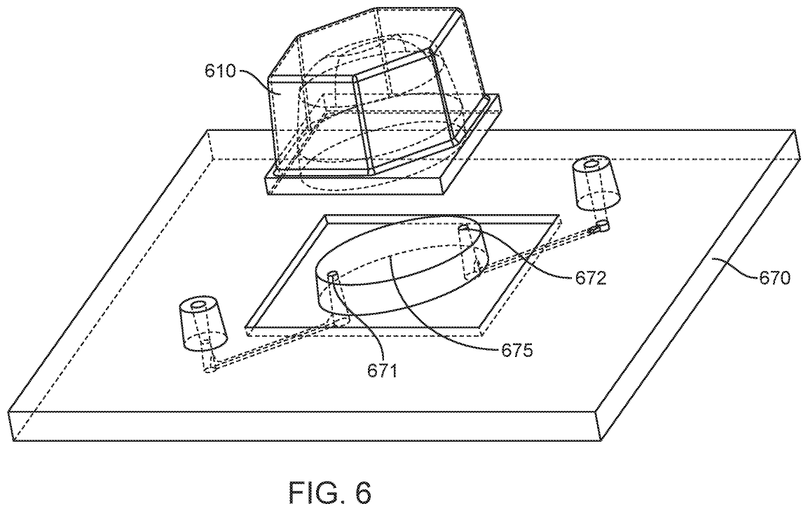

In some embodiments, the capsule is preferably shaped in such a way that it can be connected detachably and/or undetachably to a channel network of a microfluidic device, so that the dry reagent can be rehydrated and introduced into the microfluidic device. For example, as illustrated in FIG. 6, a microfluidic device 670 has a raised surface 675 that can be pushed into the opening of a capsule 610 to provide a sealed enclosure. The raised surface includes an inlet 671 to provide rehydrating fluid to the capsule 610, and an outlet to vent the capsule and/or to receive the rehydrated reagent for downstream processing. In some embodiments, the raised surface 675 is oval-shaped to fit into an oval-shaped opening of a capsule. In some embodiments, the raised surface 675 is elliptical.

Before attachment, a seal can be removed or punctured to open the capsule to fluidic flow. For example, the capsule may be attached to a device that comprises a blunt tip, a needle, or other mechanical apparatus to pierce an impermeable seal. The capsule can be attached to a device that breaks the seal on the capsule by applying pressure (e.g., fluidic pressure) to break the seal enclosing the dried reagent in the capsule. Alternatively, a seal or cap may be removed from the capsule before attaching to a device with a source of rehydrating fluid. For example, a detachable seal at the opening of a capsule may have a tab or other mechanism to facilitate removal by applying a tangential force thus exposing the opening of the capsule for attachment to a source of reagent solvent.

In some embodiments, a raised surface (e.g., the raised surface 675 of the microfluidic device) goes into the interior of the capsule to reduce the rehydration volume. Thus, in some embodiments, the volume of the capsule during preparation of the dried reagent is greater than the volume of the chamber during rehydration, due to a surface that extends further into the chamber during rehydration than any capping surface used during reagent drying. The raised surface can contact the dried reagent to push it into a smaller volume before rehydration.

In some embodiments, the raised surface 675 of the microfluidic device is elliptical. In some embodiments, the raised surface is 1.0, 1.1, 1.2, 1.3, 1.4, 1.5, 1.6, 1.7, 1.8, 1.9, or 2.0 mm high. In some embodiments, the raised surface is from 1.5-2.0 mm high. In some embodiments, the raised surface has an angled edge to facilitate entry into the capsule to form a tight seal. In some embodiments, the angled edge has a draft angle of 7, 8, 9, 10, 11, 12, 13, 14, or 15 degrees. In some embodiments the angled edge has a draft angle of approximately 10 degrees. In some embodiments, the angled edge has a draft angle from 8-12 degrees. In some embodiments, the rehydration volume is approximately 100 μL. In some embodiments, the rehydration volume is approximately 30 μL, 40 μL, 50 μL, 60 μL, 70 μL, 80 μL, 90 μL, 100 μL, 110 μL, 120 μL, 130 μL, 140 μL, or 150 μL.

Sheet/Array of Capsules

To facilitate high throughput preparation of dried reagents, sheets of capsules, vents and seals for such arrays, as well as methods of filling, drying, and sealing are provided herein. These arrays have been designed specifically to interface with commercial reagent drying chambers, while still maintaining the desirable features of each individual capsule described above. One particular problem with preparation of dried reagents, e.g., by lyophilization, in high throughput drying chambers is that mechanisms of sealing are limited. However, it is preferred to seal the capsules immediately after drying before exposing to the ambient condition. Thus, provided herein are designs that meet these needs while using the capsules as described above.

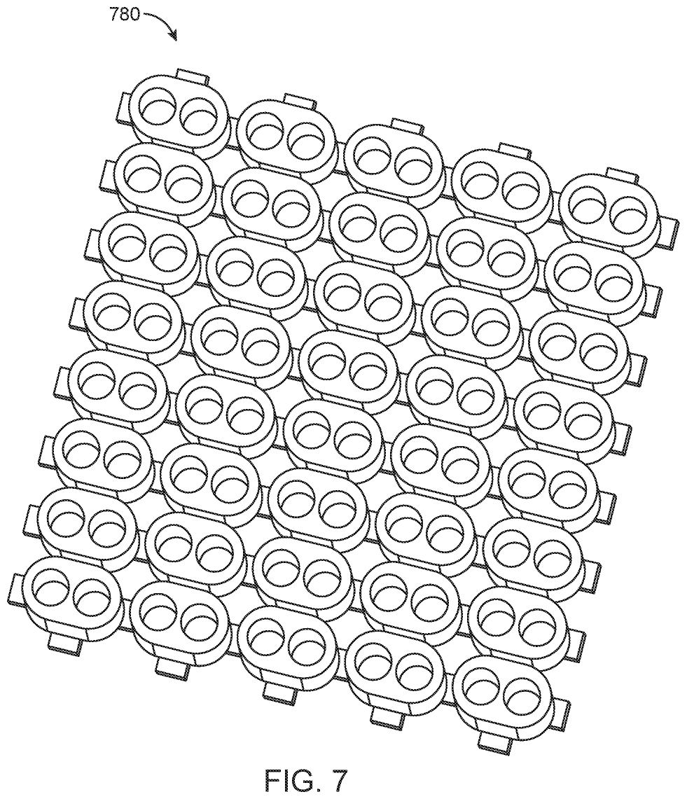

FIG. 7 illustrates a sheet 780 of capsule main bodies suitable for molding. The displayed sheet contains 40 main bodies (260 μl capacity) in an 84×88 mm area.

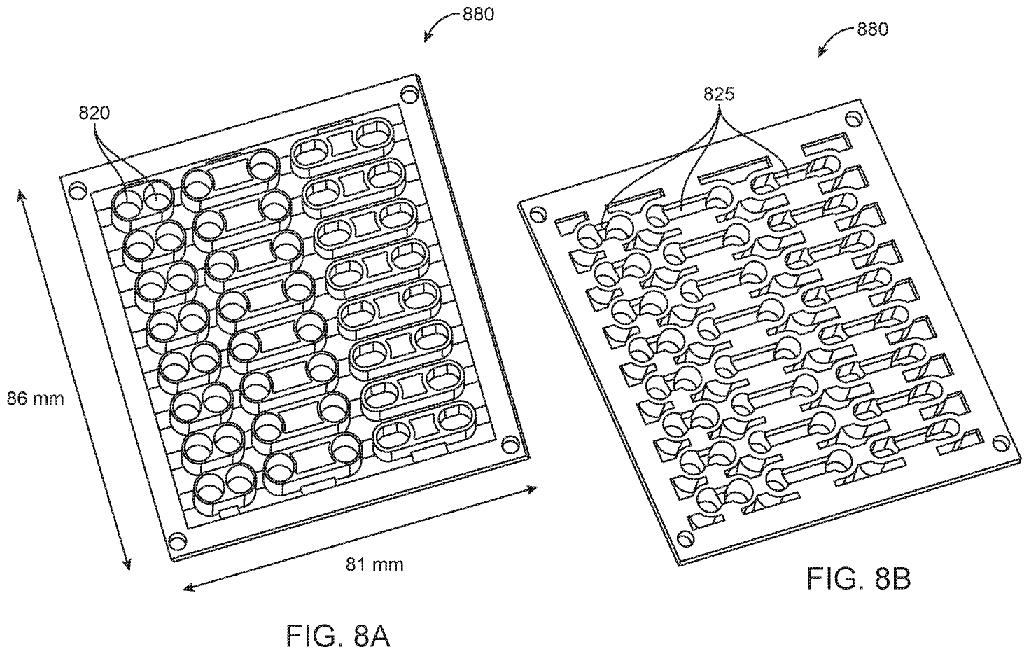

FIGS. 8A and 8B illustrates a top view (FIG. 8A) and a bottom view (FIG. 8B) of a sheet of capsule main bodies 880, in which the sheet contains three separate main body designs. Each main body comprises two flow through ports 820 and an interconnecting channel 825. The sheets illustrated in FIGS. 8A and 8B include 8 replicates each of three separate main body designs. The main bodies are arranged with 9 mm pitch spacing between replicates in order to accommodate standard multi-tip pipettes. The enclosed volume of each main body ranges between approximately 260 μL and 290 μL. Alternative capsule shapes and volumes are contemplated. For example, standard drying techniques can be applied to volumes of as little as 20-25 μL.

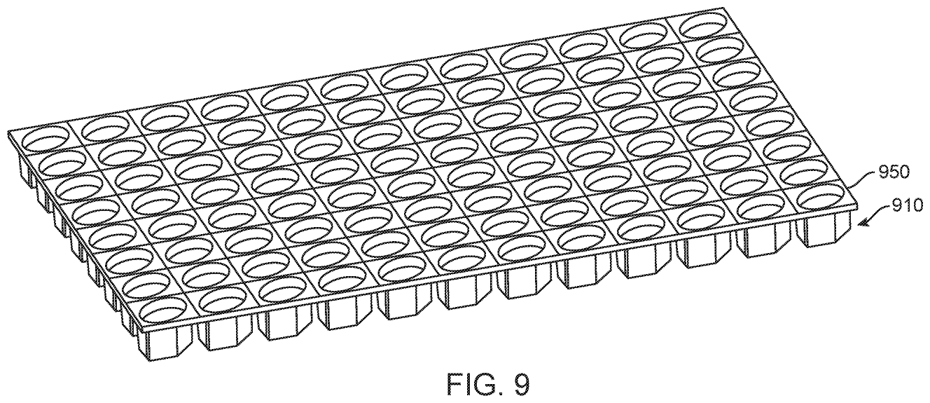

FIG. 9 illustrates a sheet of 96 capsules 910 comprising an oval-shaped opening. One example of the capsules in this array is provided in FIG. 2, described above. The planar layer 950 surrounding the oval-shaped opening of each capsule (as in FIG. 2) can be attached together to form the array. In another embodiment, the capsules may be placed into a capsule nesting array with individual slots for each capsule to form an array. Here, the capsule can be placed in a slot of the nesting array and the bottom of the planar layer can rest on the surface of the nesting array to hold each capsule in place.

In some embodiments, the capsules are spaced on the array using SBS (Society of Biomolecular Screening, ANSI SLAS 1-2004, also ANSI/SBS 1-2004) standard spacing (e.g., 9 mm pitch spacing or 4.5 mm pitch spacing) to facilitate liquid handling automation or manual loading. In some embodiments, the capsule are spaced with 8 mm pitch spacing to facilitate automated loading of liquid reagents into the capsules using Hamilton systems.

In some embodiments, the array comprises 96 capsules to allow efficient drying chamber space utilization.

To assemble an array of individual capsules, the capsules can be laser or ultrasonically welded, or heat staked bonded in place. The capsules can also be glued or solvent bonded together. In some embodiments, the capsules can be assembled into an array using a snap fit interface. In some embodiments, the capsules are assembled using complementary surfaces between each capsule, such as concave to convex, or slant to slant. In some embodiments, the assembled capsules form a sheet with a webbing or other interconnect, e.g., to facilitate manual or automated processing. These sheets can be monolithic.

In some embodiments, the array comprises multiple different reagents. In some embodiments, the array comprises the same reagent in each capsule, which can later be separated for distribution to different microfluidic devices.

In general, features disclosed herein that provide features that provide venting during drying (such as porous membranes and vented caps), and sealing for storage (such as closed caps and impermeable seals), and features that provide facilitate mixing and rehydration (such as frangible or removable seals, inlet/outlet configurations, smooth oval-shaped surfaces, interconnecting channels) are interchangeable. For example, a porous membrane and capping membrane can be used with an oval-shaped capsule, an interconnecting channel can be used in an oval-shaped channel, or a vented capping unit and/or interface unit can be used with a capsule comprising two through-ports and an interface duct.

Methods

Reagent Drying and Sealing

The devices of the invention can be useful for performing reagent or sample preservation, such as by storage and stabilization in the liquid state or dry state, including molecular (e.g. proteins, nucleic acids) and cellular and multiple biospecimens (e.g., biological fluids and human biological fluids such as blood and plasma). In general, the devices allow for drying or otherwise preserving a reagent or sample optionally combined with a matrix, storing the resultant reagent or sample in the liquid or dry state for a desired time, and then recovering the sample. Exemplary processes and devices for drying a sample or reagent using the capsules and capsule arrays of the invention are described below.

In general, a method of preparing a dried reagent sealed in a capsule of the present invention includes the following steps:
1. Providing an array of capsules capable of holding liquid reagent.
2. Inserting a reagent solution into the capsules.
3. Optionally, applying a permeable seal to cover the opening of the capsules, where the permeable seal permits vapor to pass through during drying.
4. Placing the array of capsules into a drying chamber
5. Exposing the capsules to drying conditions to remove solvent from the reagent.
6. After drying is complete, applying an impermeable seal to the opening of the capsules.
7. Removing the sealed array of capsules from the drying chamber.

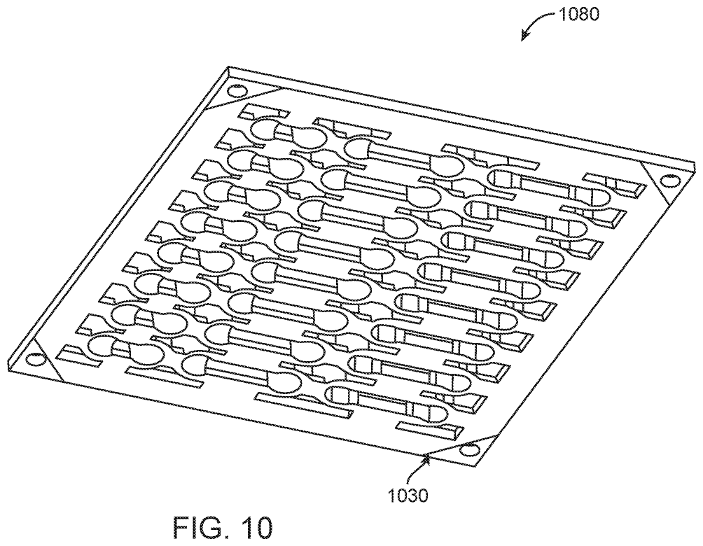

In some embodiments, capsules have an open bottom and an open top. Thus, in preparation to hold a liquid reagent, a seal is applied to the bottom of the array of capsules. For example, as shown in FIG. 10, a film with a pressure-sensitive adhesive is applied to the bottom surface of an array 1080 of capsules. This film can be an impermeable film, or a porous film that is hydrophobic. Utilizing molded sheets of main bodies and sealing films permits rapid scale up of manufacture of the capsules of the invention. The array 1080 as shown in FIG. 10 is ready for addition of reagent solution. In other embodiments, the capsules have a molded bottom, such that it is not necessary to apply a bottom seal before addition of a reagent solution.

In some embodiments, individual capsules can be placed in a nested array to form an array of capsules. An array of capsules can also be placed into a nest plate to hold the array in place and provide support during drying.

Arrays of capsules can be designed to have spacing to facilitate automated loading by existing filling lines or manual loading by multi-pipettors. Thus, an empty array of capsules can be loaded into an industry standard vial/syringe/cartridge manufacturing filling line in a similar manner as regular vials, syringes, or cartridges, and the capsules filled with a reagent formulation optimized for drying and reagent storage. In some embodiments, sample is added to an array under sterile conditions.

After loading the capsules into an array, a two-step capping system can be used to facilitate drying of the reagent, then sealing for storage. First a permeable seal can be applied which allows vapor to pass through during drying. Then, after drying, the vapor channel is closed, or an impermeable seal can be placed over the permeable seal, thereby isolating the dried reagent in the capsule environment. In preferred embodiments, the second capping is done before the capsule array is removed from the device.

A permeable seal is affixed to an array to cover the capsule openings to minimize contamination or reagent loss after loading a reagent into a capsule, while allowing vapor to pass through during drying. As described herein, this can be done by applying a laminated porous membrane to the surface of the array. This can also be done by applying a cap that comprises a venting channel or porous film to the opening of each capsule, either directly or indirectly. If the venting channel is able to be open or closed, the caps are preferably set in the open position during drying.

The capsule array is then placed into drying chamber (e.g., a lyophilizer) and subjected to reagent drying or freeze-drying conditions. During drying, vapor escapes through the permeable seal attached to each capsule. This drying step is often associated with a heat treatment to accelerate the process, or it takes the form of a freeze-drying process to protect the reagents and ensure the stability and resuspendability properties

Amorphous solids are preferred for “dry” storage of reagents because rehydration proceeds more rapidly than for the corresponding crystalline state. Ideally, for protein storage, a protein is stabilized in a solid, non-hygroscopic, glassy matrix, which undergoes a controlled devitrification when rehydrated with excess water. Biological reagents can be mixed with a suitable matrix to maintain activity during storage and increase solubility of the reagent upon rehydration.

Following a period of drying under controlled environmental conditions, the capsules arrays are sealed to isolate the dried reagent in each capsule. In preferred embodiments, this sealing occurs within the drying chamber. For example, vertical compression (e.g., of the lyophilizer chamber shelves) will push down to apply an impermeable seal across the opening of each capsule creating an array of sealed capsules containing dried reagent. In some embodiments, a custom-designed press tool can be inserted into the drying chamber. This press tool can hold a capping film or other impermeable seal above the capsule until drying is complete. Then before removal from the chamber, vertical compression is applied to the press tool to press the capping film onto the surface of the capsule array, thereby sealing each capsule.

Methods and techniques to be used to bond the sealed assembly are well known to those of ordinary skill in the art and include, e.g., gluing, welding. The bonding serves to help maintain seal integrity and provide a tamper resistant assembly which retains the sterility of the active ingredient. As such, the bonded sealed capsule closure assembly of the present invention is able to retain the sterility of the pharmaceutical powder product and is storage stable at room temperature over the shelf life of the product.

In some embodiments, vertical compression can push down on caps to close a venting channel in the cap, thereby sealing the capsule after drying.

After sealing, the sealed capsule array is removed from the drying chamber.

Press Tool Sealing

As discussed above, a custom-designed press tool can be used to apply a permeable seal for dehydration to an array of capsules, or to apply an impermeable seal within the drying chamber to the array of capsules.

Exemplary methods of sealing are provided below:

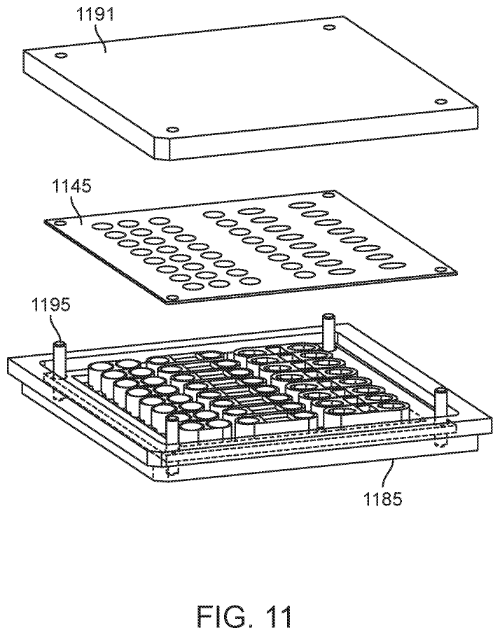

FIG. 11 illustrates the materials and process for filling capsules with reagent and applying the porous membrane to the array using a porous membrane press plate. The process comprises the following steps:
1. Insert capsule array into filling nest plate 1185.
2. Prepare reagents for drying and storage.
3. Dispense reagent into each capsule (e.g., using 8-tip, or other appropriate, pipette)
4. Remove protective liner from adhesive side of porous membrane laminate 1145.
5. Insert porous membrane through pins 1195 onto capsule sheet to seal.
6. Use the porous membrane press plate 1191 to ensure adhesion to the capsule sheet.
7. Disassemble fixture to remove filled capsule sheet.

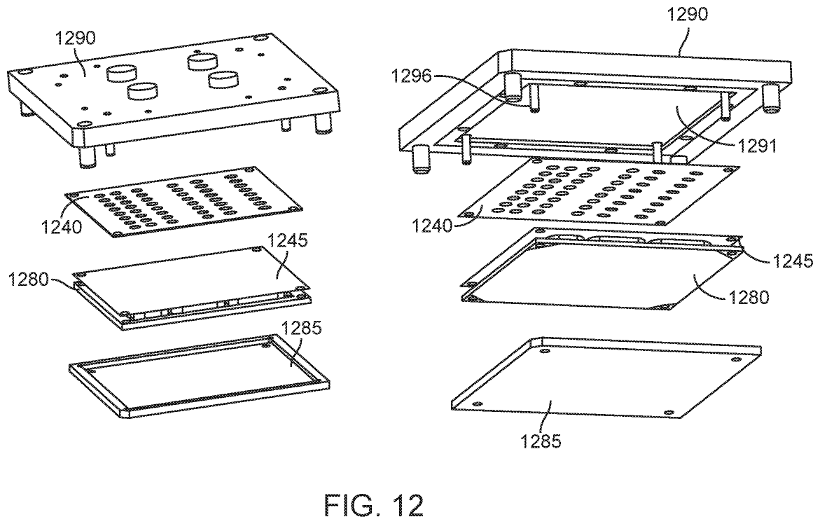

FIG. 12 provides two views of an exemplary configuration of the capsules ready for reagent drying. Beginning with the filled capsules covered by a porous membrane, the process of drying the desired reagent comprises the following steps:
1. Insert reagent-filled capsule sheet 1280 with capsule openings covered by a porous membrane 1245 into drying nest plate 1285.
2. Remove liner from adhesive side of capping film laminate sheet 1240.
3. Align and insert the non-adhesive side of the capping film laminate sheet 1240 onto the cap film press tool 1290.
4. Press the non-adhesive side of the cap film 1240 against the silicone surface 1291 to secure the film 1240 to the press tool 1290.
5. Align and insert the pins 1296 on the press tool into the locating holes on the capsule array 1280 and drying nest plate 1285.

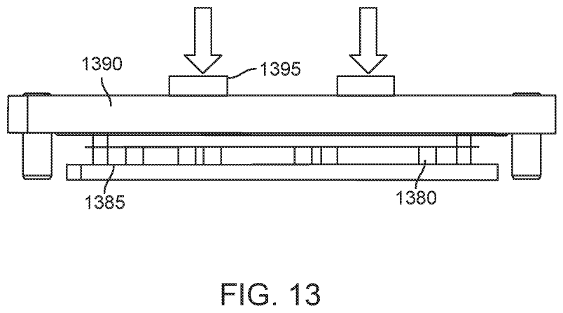

FIG. 13 illustrates the capsule assembly ready for insertion into a drying chamber (e.g., onto a lyophilization chamber shelf). When assembled prior to drying, the lower surface of the cap film press tool 1390 holding a cap film in place preferably maintains a 2-3 mm gap above the porous membrane to allow adequate vapor flow from the capsules during drying. Press pins 1395 at the top of the press plate provide an interface with a mechanism to control the movement of the press tool plate (e.g., an overhead press plate in a lyophilization chamber). Beginning with the capsule array provided in a cap film press tool holding a capping film above the top surface of the capsule array, a process for drying and sealing comprises the following steps:
1. Insert capsule array 1380 in capsule nest plate 1385 with cap film tool 1390 on to a shelf in a drying chamber.
2. Proceed with the drying process.
3. At the end of the drying process, lower the overhead press plate within the drying chamber.
4. As the press plate lowers it compresses against press pins 1395 in the cap film tool 1390.
5. The silicone sheet (1291 in FIG. 12) stretches to transfer and press the capping film against the surface of the capsule array, thereby sealing each capsule with an impermeable capping film.
6. Extract the cap film tool 1390 and capsule array 1380 from the chamber.
7. Post process: run capsule sheet through manual laminator to ensure adhesion between capping film and capsules.

In some embodiments, after extracting the capsule array, it can be run through a manual laminator to ensure adhesion between the capping film and the top surface of the capsule array. In some embodiments, an array of caps may be used instead of a capping film.

Once the upper cap film is pressed onto the capsule sheets to create the seal, long term storage of the dried reagent is possible in the same configuration, thus providing direct injection rehydration and delivery from the same component. The capping film seal also ensures long term storage for the capsule reagent and can be inserted directly into the assay instrument or device.

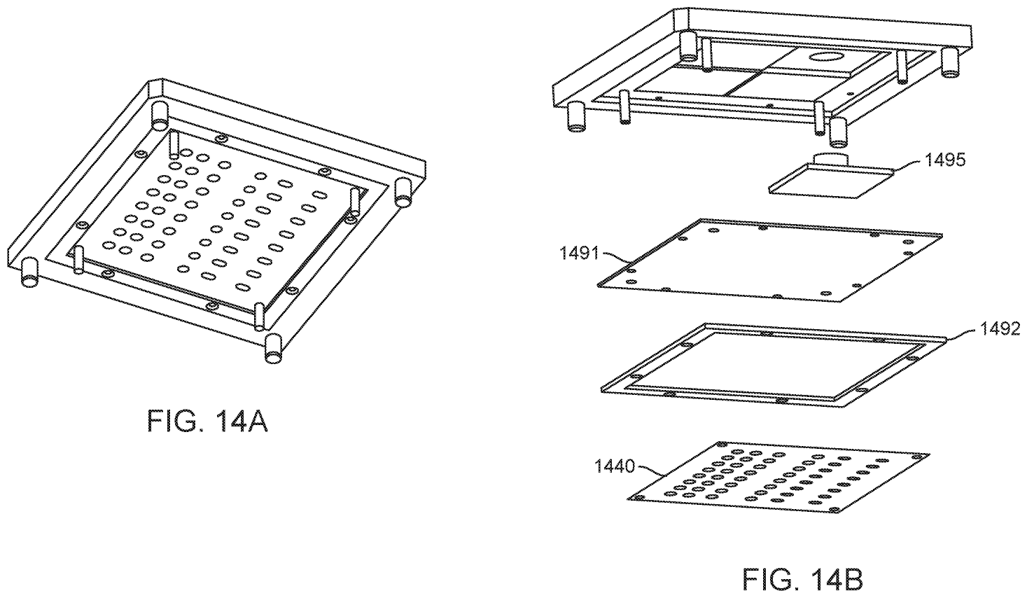

FIGS. 14A and 14B provide a bottom view and a blown-up view, respectively, of an embodiment of a press tool which can be used for the sealing methods as described above. At the end of a drying process for reagents contained in an array of capsules, an overhead press plate or other mechanism to provide vertical compression is lowered. As the press plate lowers, it compresses against press pins 1495 in the cap film tool. The silicone sheet 1491 is stretched within its frame 1492 to transfer and press the capping film laminate 1440 against the capsule array surface to seal the dried reagent from the outside environment. Optionally, after removing the apparatus from the drying chamber, the completely assembled capsule sheet can be run through a manual laminator to ensure adhesion between capping film and capsules.

Other embodiments of the press tool may vary in size and shape, but they still provide functionality to affix an impermeable seal onto a capsule array when vertically compressed within a drying chamber. In some embodiments, the pins that hold the laminate sheet in place can have mechanisms to secure the sheet, such as washers or tabs. This prevents movement of the capping film seal onto the capsule array before drying is complete.

Reel to Reel Sealing

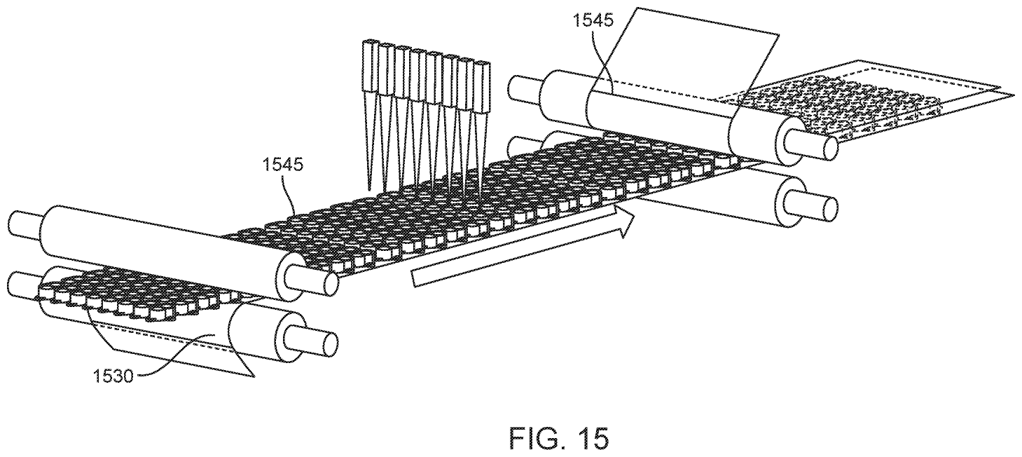

In some embodiments, reel to reel sealing can be used to prepare an array of capsules for drying. An exemplary embodiment of reel to reel sealing to prepare for reagent drying is illustrated in FIG. 15. As shown a line of capsule arrays moves in a direction indicated by the arrow adjacent to the row of capsules. In the manner, each array of capsules first passes through a reel containing a bottom sealing film 1530 to seal the bottom of each capsule. Then, the array of capsules moves to a filling area where reagent is added to each capsule. Finally, the array of capsules moves between a set of reels containing a porous membrane seal to apply to the top of each capsule. After reel to reel sealing and reagent filling, each capsule array is ready to insert into a drying chamber.

In some embodiments, the bottom of each capsule is already molded, such that the first set of reels comprising the bottom sealing film is not used. In some embodiments, a similar reel to reel process can be used to apply or ensure the sealing of a capping film to the top of an array capsule.

During automated filling, a single reagent can be placed into each array, or each capsule in an array can contain different reagents to generate a large product mix.

In some embodiments, reel to reel processing can be used after drying, for example to apply a capping film, or to pick individual capsules from each array for subsequent processing.

Caps for Array Sealing

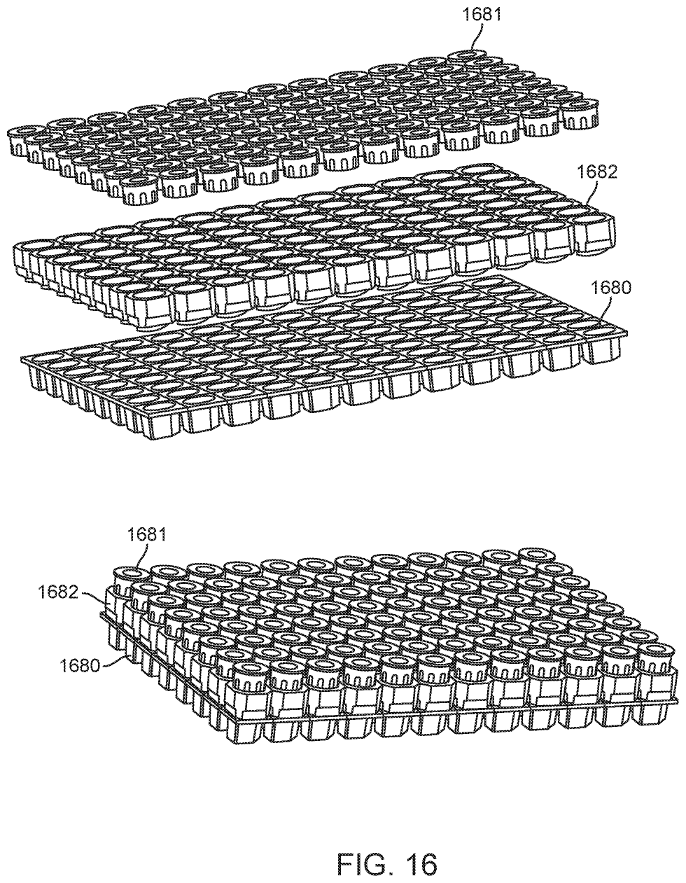

Arrays of capsules can be sealed using caps in a similar manner as discussed for individual capsules. Shown in FIG. 16 is an example of sealing an array of capsules with an array of caps. As shown, each capsule has an oval-shaped opening, while each cap is rounded. Thus an interface layer 1682 is also provided to provide a fluid-tight engagement between the each cap of the array of caps 1681 and each capsule of the array of capsules 1680. When pressed together, the capsules array is now sealed. In some embodiments, each cap comprises an adjustable venting mechanism. Thus, when this vent open, the array of capsules pressed together with the interface layer and cap layer is ready for drying. In some embodiments, the caps, when vertical force is applied to push down on the caps, the venting mechanism is closed, thereby sealing each of the capsules in the array. Therefore, the array of caps is compatible with sealing in a drying chamber where a vertical force can be applied to push down onto the top of the array of caps.

In some embodiments, the cap layer can be applied directly to the opening of the capsule to seal each capsule.

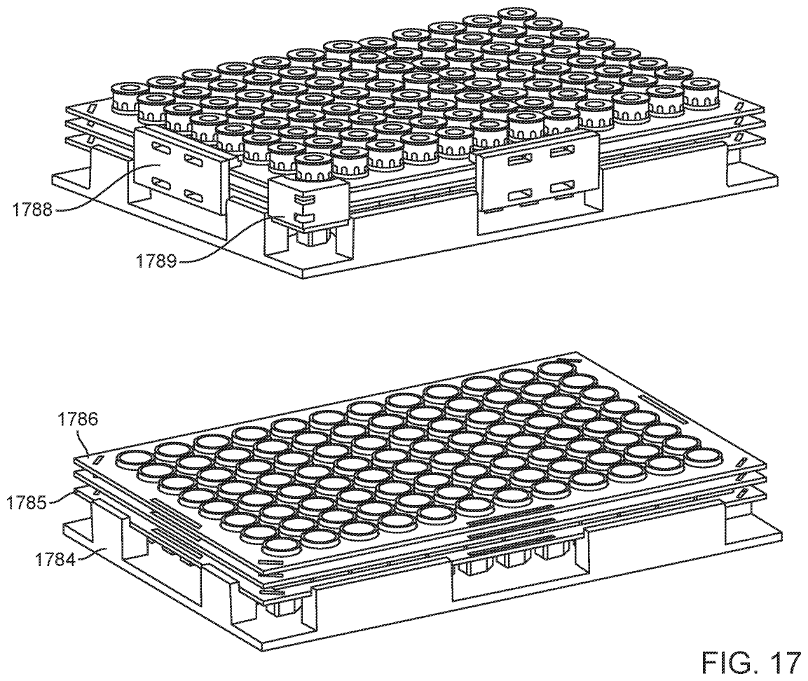

In some embodiments, nest plates and clips can be used to place individual capsules in an array and to ensure capsules remain sealed. For example, as shown in FIG. 17, an array of interface units in an interface nest plate 1786 is placed on top of an array of capsules contained within a capsule nest plate 1785. These arrays can be held within a support plate 1784 for nest assembly and reagent filling. The interface array can be pushed into the capsule array to form a fluid tight engagement between each interface unit and each capsule. Edge clips 1788 and/or corner clips 1789 can be applied to the edges of each nest plate to hold the fluid tight engagement in place. Caps can be pushed into each interface unit to form a fluid tight engagement between each cap and interface unit, thereby providing a sealed environment for each capsule in the array.

Pick and Place

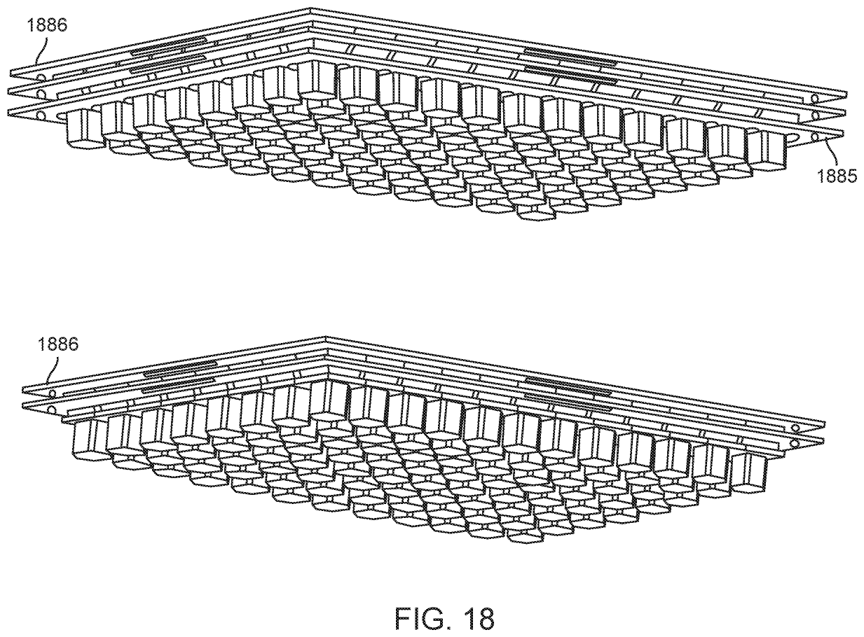

In some embodiments, an array of capsules can be singulated to provide individualized capsules comprising dried reagent for downstream applications. Singulation can occur with a dicing saw process, or can be achieved by removal of a capsule from a nest plate. Singulation with laser cutting is a dry, clean method which is advantageous for dried reagent storage applications. Alternatively, a monolithic capsule array sheet can be molded with small webbing interconnects that can be fractured under controlled loads. In some embodiments, a capsule can be removed from an array of interface units or an array of caps. Thus, an array of interface units or array of caps can serve as a pick and place tray. As illustrated in FIG. 18, a capsule nest plate 1885 can be removed from the capsule array, while an interface nest plate 1886 is retained. In this manner, the array of interface units serves as a pick and place tray where individual capsules can be easily removed. Such a nest tray assembly of components is for use with array of singlet capsule and interfacing components and caps. If capsule array are manufactured as a monolithic sheet, the nest tray is optional.

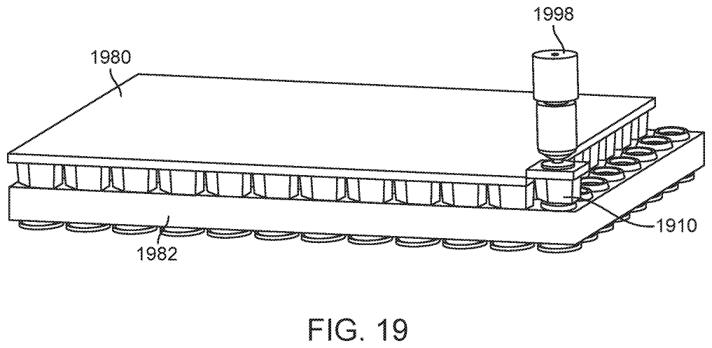

One suitable technique for removing a capsule of the present invention from an array of capsules involves the use of a gripping mechanism (e.g., negative air pressure) to selectively pick the capsule off of the cap assembly or other tray or container holding the capsule. FIG. 19 depicts an embodiment of removing a capsule from an array of capsules held by a tray using vacuum pressure. As shown, an array of interface units 1982 acts as a pick and place tray for the capsule array 1980. A singulated capsule 1910 can be easily removed by a pick and place tool 1998 using vacuum pressure.

This air pressure removal technique allows for easy removal of a singulated capsule. Alternatively, it is contemplated that any suitable gripping mechanism or device may be used which can grip the capsule and remove it from the array. In some embodiments, the capsule array can be inverted, such that a capsule is removed from the bottom of the tray, to protect dried reagent during transfer. The orientation of the array of capsules during removal is not limited to these embodiments and can be done in any orientation.

It will be apparent to one of skill in the art that any suitable technique for removing a singulated capsule may be used, or alternatively, the array be maintained during shipping and storage until the contents of the capsule are to be used by the end user.

In preferred embodiments, a dried reagent is stored in a sealed capsule under controlled conditions while retaining biological activity. For example, a TAQ polymerase “retains its biological activity” in a reagent composition, if the biological activity of the biologically active material is efficacious at any given time in performing a PCR amplification. A preferred dried reagent has a shelf life of greater than 6 months

Storage Stable Dried Reagent Formulations.

In some embodiments, the dried reagent formulations of the present invention are optimized to produce dried reagents which provide for “rapid” dissolution, i.e., the dried reagent is readily and immediately dissolved upon contact with a liquid solvent. The dried reagents of the present invention can comprise an active ingredient, e.g., a protein, and a stabilizer.

In some embodiments the stored reagents can be included in stabilizing matrices (e.g. trehalose) or in other forms, such as the Biospheres commercialized by Biolyph Corporation. Stabilizers such as, e.g., surfactants, sugars, polymers, antioxidants, amino acids, salts, can be added to stabilize the active ingredient during a freezing process, or to replace hydrogen bonds of water during dehydration process, e.g., sucrose, trehalose, lactose, or other sugars.

In some embodiments, lyoprotectants may be added to a reagent solution to protect a protein in a reagent from denaturation during dry storage. A lyoprotectants is a molecule that protects a protein, primer or probe, for example a TAQ polymerase, from denaturation and loss of biological activity during dry storage. Many lyoprotectants are polyols, but the class may also include amino acids, peptides, proteins, as well as PHCs, sugars, polyvinylpyrrolidinones, PEGs, and the like. It should be understood that the definition also includes co-lyoprotectants, where a first substance and a second substance having a synergic protective effect with the first are used in a mixture.

Candidate lyoprotectants include polyhydroxy compounds (PHCs) generally, particularly a variety of sugars (including monosaccharides, disaccharides, trisaccharides, and oligosaccharides), sugar alcohols, and a variety of polyhydroxy small molecules and polymers. Lactitol, mannitol, maltitol, xylitol, erythritol, myoinositol, threitol, sorbitol (glucitol), and glycerol are examples of sugar alcohols. Non-reducing sugars include sucrose, trehalose, sorbose, stachyose, gentianose, melezitose and raffinose. Derivatives of sugars that are lyoprotectants include methylglucoside and 2′-deoxyglucose, among others. Sugar acids include L-gluconate and metallic salts thereof. Less preferred for most applications include reducing sugars such as fructose, apiose, mannose, maltose, isomaltulose, lactose, lactulose, arabinose, xylose, lyxose, digitoxose, fucose, quercitol, allose, altrose, primeverose, ribose, rhamnose, galactose, glyceraldehyde, allose, apiose, altrose, tagatose, turanose, sophorose, maltotriose, manninotriose, rutinose, scillabiose, cellobiose, gentiobiose, and glucose. Also useful are polyvinylpyrrolidones, polyacrylamide, polyethylimine, pectin, cellulose, derivatized celluloses such as hydroxymethylcellulose, hydroxyethylcellulose, and hydroxypropylmethylcellulose, hydroxyethylstarch, soluble starches, dextrans, highly branched, high-mass, hydrophilic polysaccharides such as Ficoll®. Glass-forming albumins, gelatins and amino acids have also found use. By trial and error, useful mixtures of the above have also been discovered, typically differing for each target protein.

In order to maintain large surface area, the reagent formulations may further comprise bulking agents that can form crystalline matrices (e.g., mannitol, glycine, polyethylene glycol, and the like). Alternatively, other glassy bulking agents like sugars and polymers, e.g., sucrose, trehalose, lactose, proteins, dextran and its derivatives, cyclodextran, carboxymethylcellulose, PVA, PVC, starch and its derivatives, can be added to the formulation.

The reagent formulations may further comprise surfactants and buffers. Such surfactants include polysorbate 80 (or Tween 80), polysorbate 20 (or Tween 20), or pluronics. Such buffers include, e.g., phosphate, histidine, imidazole, citrate, acetate, succinate, glutamate, Tris and glycine can be added to keep desirable pH.

In order to minimize the mass that needs to be dissolved during rehydration, the formulation can be composed mostly by active ingredients. For example, protein or peptide products can be lyophilized with the final solid content of 95% of protein or peptide and 5% of stabilizer.

The dried reagents which can be stored in the capsules of the present invention and rehydrated include salts, buffers for, e.g., cell lysis, magnetic and non-magnetic beads, enzymes, antibodies, DNA fragments, proteins, and PCR reagents, or alternatively even cells.

Protein reagents that may be dried, stored, and delivered to a microfluidic cartridge for a molecular biological assay include: TAQ polymerase, DNA polymerase, RNA polymerase, reverse transcriptase, RNAase H, proteinase K, immunoglobulin, luciferase, pyrophosphatase, chromopeptidase, lysozyme, and so forth. Other reagents likely to have sensitivity to light, moisture or heat include nucleotide triphosphates, deoxynucleotide triphosphates, primers and probes.

In some embodiments, the dried reagents can include amplification reagents, such as for LAMP detection. The reagents stored in the capsule can also include indicators for visual readout that can be dried together with the other reagents or dried independently.

The matrices described herein (e.g., stabilization matrices) can allow for dry sample preservation at room temperature. Exemplary matrices are available from suppliers including but not limited to Biomatrica, IntegenX/Genvault, Qiagen, and General Electric. Exemplary commercially available stabilization matrices include Biomatrica, DNAstable®/DNAstable® LD, DNAstable® Blood, DNAgard® Blood, DNAgard® Saliva, DNAgard® Tissue, RNAstable®, RNAgard®, Clonestable®, IntegenX/Genvault, GenTegra DNA, GenTegra RNA, GenPlate, Luna Innovations, Qiagen, Allprotect Tissue Reagent, RNAlater® RNA Stabilization Reagent, GE Healthcare/Whatman plc, and FTA paper. Additional matrices include those having a desiccant (e.g., any described herein), a weak base, a chelating agent, an anionic surfactant or detergent, a uric acid, a salt (e.g., a urate salt, either alone or added to a cellulose based matrix (filter paper) to inactivate nuclease; or a sulfate salt, such as ammonium sulfate, ammonium bisulfate, cesium sulfate, cadmium sulfate, cesium iron (II) sulfate, chromium (III) sulfate, cobalt (II) sulfate, copper (II) sulfate, lithium sulfate, magnesium sulfate, manganese sulfate, potassium sulfate, sodium sulfate, or zinc sulfate), and/or an oligosaccharide (e.g., trehalose, sucrose, maltose, etc. to stabilize DNA, RNA, or protein for anhydrobiosis, lyophilization, vitrification, and/or room temperature air drying). In particular embodiments, the matrix includes a sulfate salt (e.g., an ammonium sulfate, including a final salt concentration in solution is between 10 g/100 ml and a saturating concentration (e.g., 100 g/100 mL)), an optional chelator (e.g., EDTA), a buffer (e.g., having a pH between 4 and 8), or a precipitant (e.g., ethanol, methanol, acetone, trichloroacetic acid, 1-propanol, 2-propanol, polyethylene glycol, or acetic acid). In other embodiments, the matrix includes (i) 1-methyl-3-carboxyethyl-imidazolium bromide, 1-hexyl-3-methylimidazolium bromide, 1-decyl-3-methylimidazolium bromide, 1-(2-hydroxyethyl)-3-methylimidazolium bromide, or 1-benzyl-3-hexylimidazolium bromide; and (ii) one or more of a precipitating agent (e.g., 5-(4-dimethyl)amino benzylidene rhodanine, sulfosalicylic acid, lithium chloride, or lithium hydroxide), a lower alcohol (e.g., methanol, ethanol, n-propanol, isopropanol, n-butanol, or isobutanol (2-methylpropan-1-ol)), or a chaotropic substance (e.g., any described herein). Such matrices can also include an optional chelating agent (e.g., any described herein), an optional reducing agent (e.g., any described herein), an optional pH buffer (e.g., any described herein), and optionally water. In some embodiments, the matrix includes (i) a borate composition (e.g., boric acid, boric anhydride, dihydrogen borate, hydrogen borate, diborate, triborate, tetraborate, metab orate, hydroxoborate (borax), borate salt, boric acid-glycerol, or boric-acid-1,3 propanediol) and (b) at least one stabilizer (e.g., hydroxyectoine, ectoine, homoectoine, betaine, L-carnitine, sarcosine, N,N-dimethylglycine, triethylammonium acetate, glycerol phosphate, N-(2-hydroxy-1,1-bis(hydroxymethyl)ethyl)glycine (tricine), 3-(N-morpholino)-2-hydroxypropanesulfonic acid (MOPSO), pentaerythritol, N-ethyl-N,N-bis-(2-hydroxyethyl)ammonium-N-4-butyl sulfonate, glycolic acid, lactic acid, malic acid, tartaric acid, 2-hydroxybutyric acid, 3-hydroxybutyric acid, 4-amino-3-hydroxybutyric acid, pyridine 2,5-dicarboxylic acid, 3-(1-azoniabicyclo[2.2.2]oct-1-yl)propane-1-sulfonate, 1-(2-carboxylatoethyl)-1-azabicyclo[2.2.2]octan-1-ium, or 4-[benzyl(2-hydroxyethyl)methylazaniumyl]butane-1-sulfonate). In yet other embodiments, the matrix includes (i) a liquid or dry material (e.g., polyvinyl alcohol) and (ii) a stabilizer (e.g., any described herein, including a trehalase stabilizer, a glycosidase inhibitor, a trehalase inhibitor (e.g., suidatrestin, validamycin A, validoxylamine A, MDL 26537, trehazolin, salbostatin, or casuarine-6-O-alpha-D-glucopyranoside), a chitinase inhibitor, an alpha-glucosidase inhibitor, a glycogen phosphorylase inhibitor, a neuraminidase inhibitor, a ceramide glucosyltransferase inhibitor, a beta-fructofuranosidase inhibitor (e.g. alpha-methyl glucoside, cellobiose, D-fructose, D-glucose, fructose, galactose, glucose, lactose, maltose, melezitose, melibiose, sucrose, trehalose, or turanose), or a lysosomal glycosidase inhibitor. In other embodiments, the matrix includes (i) a liquid or dry material (e.g., polyvinyl alcohol) and (ii) a stabilizer (e.g., any described herein, including a combination of trehalose and a trehalase inhibitor, such as any described herein). Further matrices are provided in U.S. Pat. Nos. 6,528,641 or 5,256,571, as well as U.S. Pub. Nos. 2005-0276728, 2006-0099567, 2008-0176209, 2008-0268514, 2011-0081363, and 2012-0052572, each of which is incorporated by reference in its entirety.

Component Manufacture

The materials used to form the devices of the invention are selected with regard to physical and chemical characteristics that are desirable for proper functioning of the device. Suitable, non-limiting materials include polymeric materials, such as silicone polymers (e.g., polydimethylsiloxane and epoxy polymers), polyimides (e.g., commercially available Kapton® (poly(4,4′-oxydiphenylene-pyromellitimide, from DuPont, Wilmington, Del.) and Upilex™ (poly(biphenyl tetracarboxylic dianhydride), from Ube Industries, Ltd., Japan)), polycarbonates, polyesters, polyamides, polyethers, polyurethanes, polyfluorocarbons, fluorinated polymers (e.g., polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluoropolyether, perfluorosulfonic acid, perfluoropolyoxetane, FFPM/FFKM (perfluorinated elastomer [perfluoroelastomer]), FPM/FKM (fluorocarbon [chlorotrifluoroethylenevinylidene fluoride]), as well as copolymers thereof), polyetheretherketones (PEEK), polystyrenes, poly(acrylonitrile-butadiene-styrene)(ABS), acrylate and acrylic acid polymers such as polymethyl methacrylate, and other substituted and unsubstituted polyolefins (e.g, cycloolefin polymer, polypropylene, polybutylene, polyethylene (PE, e.g., cross-linked PE, high-density PE, medium-density PE, linear low-density PE, low-density PE, or ultra-high-molecular-weight PE), polymethylpentene, polybutene-1, polyisobutylene, ethylene propylene rubber, ethylene propylene diene monomer (M-class) rubber), and copolymers thereof (e.g., cycloolefin copolymer); ceramics, such as aluminum oxide, silicon oxide, zirconium oxide, and the like); semiconductors, such as silicon, gallium arsenide, and the like; glass; metals; as well as coated combinations, composites (e.g., a block composite, e.g., an A-B-A block composite, an A-B-C block composite, or the like, of any materials described herein), and laminates (e.g., a composite material formed from several different bonded layers of identical or different materials, such as polymer laminate or polymer-metal laminates, e.g., polymer coated with copper, a ceramic-in-metal or a polymer-in-metal composite) thereof.

Different components can be connected by means of welding, adhesive bonding, interlocking features, or other mechanisms known to those of skill in the art. The individual channels, ports, capsules and other features of the devices provided herein are cut, embossed or molded in the layers by one of a variety of processes. The device can be formed by any useful process, including but not limited to molding (e.g., injection molding, vacuum molding, or overmolding), machining (e.g., drilling, milling, or sanding), and etching (e.g., deep reactive ion etching, KOH etching, or HF etching), or any combination of the above.

### EQUIVALENTS AND SCOPE

Those skilled in the art will recognize, or be able to ascertain using no more than routine experimentation, many equivalents to the specific embodiments in accordance with the invention described herein. The scope of the present invention is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise.

All cited sources, for example, references, publications, databases, database entries, and art cited herein, are incorporated into this application by reference, even if not expressly stated in the citation. In case of conflicting statements of a cited source and the instant application, the statement in the instant application shall control.

Section and table headings are not intended to be limiting.

### Other Embodiments

It is to be understood that the words which have been used are words of description rather than limitation, and that changes may be made within the purview of the appended claims without departing from the true scope and spirit of the invention in its broader aspects.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

1. A reagent storage component comprising:
a capsule capable of holding a liquid or solid sample, said capsule comprising an opening, a closed end and a wall extending from the closed end to the opening, wherein the capsule is oval-shaped and the wall is rounded, and wherein the closed end and wall define an interior volume having a substantially smooth surface.

2. (canceled)

3. The reagent storage component of claim 1, wherein said closed end is part of a continuous component with said wall.

4. The reagent storage component of claim 3, wherein said closed end comprises a concave shape extending from the bottom of the capsule.

5-31. (canceled)

32. A reagent storage component comprising:
a capsule capable of holding a liquid or a solid sample, said capsule comprising an inner surface extending from the bottom of said capsule to an oval-shaped opening at the top of the capsule, wherein said inner surface is substantially smooth and comprise a concave shape extending from the bottom of the capsule; and
a planar layer affixed around the oval-shaped opening of said capsule and oriented in the same plane as the oval-shaped opening of said capsule, wherein said planar layer comprises a top surface and a bottom surface, said top surface aligned with the inner surface of said capsule at said oval-shaped opening to provide a continuous surface.

33. (canceled)

34. (canceled)

35. The reagent storage component of claim 32, wherein said opening is elliptical.

36. The reagent storage component of claim 32, wherein the inner surface of said capsule comprises an ovoidal shape.

37. The reagent storage component of claim 32, wherein the inner surface of said capsule comprises an ellipsoidal shape.

38-40. (canceled)

41. The reagent storage component of claim 32, wherein said capsule is capable of holding a volume from approximately 50 μL to approximately 200 μL.

42. (canceled)

43. The reagent storage component of claim 32, wherein said oval-shaped opening is contained within an area of 9 mm×9 mm.

44-48. (canceled)

49. The reagent storage component of claim 32, wherein said capsule comprises a dried reagent.

50. (canceled)

51. A module comprising a reagent storage component of claim 32 and a cap directly or indirectly mounted to the opening of said capsule to form a fluid tight engagement with said capsule.

52. The module of claim 51, wherein said cap comprises an adjustable venting channel capable of being moved from an open position, wherein the venting channel is open to allow air to pass through said cap, to a closed position, wherein the venting channel is closed to prevent air from passing through said cap.

53. The module of claim 51, further comprising an interface unit mounted between said capsule opening and said cap, said interface unit comprising a through hole, said through hole aligning said capsule with said cap such that said cap is indirectly mounted to the opening of said capsule to form said fluid tight engagement.

54-59. (canceled)

60. The module of claim 53, wherein said cap is inserted into the interior of the top of the through hole of the interface unit to form a fluid tight engagement between said cap and said interface unit.

61-65. (canceled)

66. An array comprising a plurality of reagent storage components of claim 32.

67. The array of claim 66, wherein the planar layers of each of the plurality of reagent storage components are attached to each other to form a continuous plane, thereby forming said array.

68. The array of claim 66, wherein the array comprises a plurality of said reagent storage components immobilized in a nesting layer, said nesting layer comprising a plurality of slots configured to hold said plurality of reagent storage components.

69-80. (canceled)

81. A microfluidic device comprising:
an oval-shaped raised surface on the microfluidic device, wherein said oval-shaped raised surface comprises an inlet and an outlet, said raised surface comprising edges that form a fluid tight engagement with the inner surface of said capsule of said reagent storage component; and
a reagent storage component of claim 32, wherein said oval-shaped opening is engaged with said raised surface to form a fluid tight seal to compartmentalize said capsule.

82. The device of claim 81, wherein said capsule comprises a mixing element.

83. The device of claim 82, wherein said mixing element comprises a magnetic bead.

84. The device of claim 81, wherein said capsule comprises a dried reagent.

85-102. (canceled)

103. A method of rehydrating a dried reagent, comprising:
providing the reagent storage component of claim 49;
flowing a rehydrating fluid into said capsule, thereby dissolving said dried reagent; and
flowing said rehydrating fluid comprising said dissolved reagent out of said capsule through said inlet.

104-107. (canceled)

108. The method of claim 103, further comprising attaching said reagent storage component to a microfluidic device comprising an inlet and an outlet, wherein said inlet and said outlet are in fluid communication with the interior of said capsule when said reagent storage component is attached to said microfluidic device.

109. The method of claim 108, wherein said rehydrating fluid flows into said capsule via said inlet, and wherein said rehydrating fluid flows out of said capsule via said inlet or said outlet.
